(19) United States
(12) Patent Application Publication
(10) Pub. No.: US 2014/0027673 A1
(43) Pub. Date: Jan. 30, 2014

(54) METHOD OF MAKING COMPONENTS INCLUDING QUANTUM DOTS, METHODS, AND PRODUCTS

(71) Applicant: QD VISION, INC., Lexington, MA (US)

(72) Inventors: Robert J. NICK, Pepperell, MA (US); Craig Alan BREEN, Somerville, MA (US); Chad M. DENTON, Cambridge, MA (US); Sridhar SADASIVAN, Somerville, MA (US); John R. LINTON, Concord, MA (US)

(73) Assignee: QD VISION, INC., Lexington, MA (US)

(21) Appl. No.: 13/762,354

(22) Filed: Feb. 7, 2013

Related U.S. Application Data
(60) Provisional application No. 61/675,773, filed on Jul. 25, 2012.

(51) Int. Cl. C09K 11/02

(52) U.S. Cl. CPC C09K 11/025
USPC 252/301.6 S

(57) ABSTRACT

A quantum dot formulation substantially free of oxygen and, optionally, substantially free of water and a method of making a quantum dot formulation substantially free of oxygen and, optionally, substantially free of water is described. Also described are products including the quantum dot formulation described herein and related methods.

### CLAIM OF PRIORITY

This application claims priority to U.S. Provisional Patent Application No. 61/675,773, filed on Jul. 25, 2012, which is hereby incorporated herein by reference in its entirety for all purposes.

### TECHNICAL FIELD OF THE INVENTION

The present invention relates to the technical field of quantum dots and methods, compositions and products including quantum dots.

### BRIEF SUMMARY OF THE INVENTION

Embodiments of the present invention are directed to a method of making a quantum dot formulation substantially free of oxygen and, optionally, substantially free of water. The methods include combining quantum dots substantially free of oxygen and, optionally, substantially free of water and one or more components substantially free of oxygen and, optionally, substantially free of water to form the quantum dot formulation substantially free of oxygen and, optionally, substantially free of water.

Embodiments of the present invention are directed to a method of improving efficiency of an optical component comprising making a quantum dot formulation substantially free of oxygen comprising combining quantum dots substantially free of oxygen and one or more components substantially free of oxygen to form the quantum dot formulation substantially free of oxygen, and incorporating the quantum dot formulation into the optical component.

Embodiments of the present invention are directed to a method of improving lifetime of an optical component comprising making a quantum dot formulation substantially free of oxygen comprising combining quantum dots substantially free of oxygen and one or more components substantially free of oxygen to form the quantum dot formulation substantially free of oxygen, and incorporating the quantum dot formulation into the optical component.

According to one aspect, the quantum dot formulation may be a combination of certain quantum dots, such as quantum dots that emit green light wavelengths and quantum dots that emit red light wavelengths, that are stimulated by an LED emitting blue light wavelengths resulting in the generation of a light of one or more wavelengths including, e.g., and without limitation, trichromatic white light. According to one aspect, the quantum dots are contained within an optical component such as a container, for example a vessel, tube or capillary or as a film in a container under oxygen-free conditions and, optionally, water-free conditions, and which receives light from an LED. Light generated by the quantum dots can be delivered via a light guide for use, for example, with display units. According to certain aspects, light generated by quantum dots, such as trichromatic white light, is used in combination with a liquid crystal display (LCD) unit or other optical display unit, such as a display back light unit. One implementation of the present invention includes a combination of the quantum dots within a tube under oxygen-free conditions and water free conditions, an LED blue light source and a light guide for use as a backlight unit which can be further used, for example, with an LCD unit.

Quantum dots reside within the container and may be contained within a polymerized matrix material which is light transmissive. A quantum dot formulation including quantum dots and a polymerizable composition (e.g., a monomer or other polymerizable or curable material) and which is substantially free of oxygen and, optionally, substantially free of water can be introduced into the container under oxygen free and, optionally, water free conditions. The container may be sealed to maintain the oxygen-free nature of the polymerizable composition. In certain embodiments, the polymerizable composition is polymerized within the container using light or heat, for example, after the container is sealed. According to certain aspects, the container may be a tube preferably having sufficient tolerance or ductility to avoid, resist or inhibit cracking during the curing of the monomers into a polymerized matrix material within the tube. The tube preferably also has sufficient tolerance or ductility to avoid, resist or inhibit cracking during thermal treatment of the tube with the polymerized quantum dot matrix therein. According to certain aspects, the components for making a polymerized quantum dot matrix include polymerizable materials exhibiting ductility when polymerized. According to certain aspects, the polymerized matrix under oxygen-free and, optionally, water free conditions within the sealed tube provides advantageous light emitting properties.

Embodiments of the present invention are directed to the mixtures or combinations or ratios of quantum dots that are used to achieve certain desired radiation output. Such quantum dots can emit red and green light of certain wavelength when exposed to a suitable stimulus.

Still further embodiments are directed to various formulations including quantum dots which are used in various light emitting applications. Formulations including quantum dots may also be referred to herein as “quantum dot formulations” or “optical materials”. For example, quantum dot formulations substantially free of oxygen and, optionally, substantially free of water can take the form of flowable, polymerizable fluids, commonly known as quantum dot inks, that are introduced into the container under oxygen free and, optionally, water free conditions, the container is then sealed to prevent oxygen and, optionally, water from entering the container and then the polymerizable fluid is polymerized to form a quantum dot matrix. The container can then be used in combination with a light source and/or light guide, for example.

Such formulations include quantum dots and a polymerizable composition such as a monomer or an oligomer or a polymer capable of further polymerizing. Additional components include at least one or more of a crosslinking agent, a scattering agent, a rheology modifier, a filler, a photoinitiator or thermal initiator and other components useful in producing a polymerizable matrix containing quantum dots. Such additional components are described in U.S. Ser. No. 61/562,469 filed Nov. 22, 2011 and incorporated by reference. According to one aspect, the quantum dots are made such that they are substantially free of oxygen and, optionally, substantially free of water. Components to be combined with the quantum dots to form a quantum dot formulation are processed such that they are substantially free of oxygen and, optionally, substantially free of water. The quantum dots and the components are combined under oxygen free conditions and, optionally, water free conditions to form a quantum dot formulation substantially free of oxygen and, optionally, substantially free of water. The quantum dot formulation can then be placed into a container or on or over a substrate under oxygen free conditions and water free conditions and the container or substrate can then be sealed to avoid ingress of oxygen and water to the quantum dot formulation. The container or substrate with the quantum dot formulation therein or thereon is subjected to conditions such that the quantum dot formulation cures or otherwise polymerizes to form a quantum dot matrix substantially free of oxygen and, optionally, substantially free of water. In certain embodiments, a tube or a capillary can be a container.

Embodiments of the present invention are still further directed to various backlight unit designs including the quantum dot-containing containers, LEDs, and light guides for the efficient transfer of the generated light to and through the light guide for use in liquid crystal displays. According to certain aspects, methods and devices are provided for the illumination and stimulation of quantum dots within tubes and the efficient coupling or directing of resultant radiation to and through a light guide.

Additional aspects include methods for introducing a quantum dot formulation into a container under oxygen-free conditions and then sealing the container, such as under oxygen free conditions, such that the quantum dot formulation within the sealed container is under an oxygen-free environment. Certain aspects include providing a container design such as a tube design, having one or both ends sealed, which withstands stresses relating to polymerization of a polymerizable quantum dot formulation therein or stresses relating to heating the tube containing the polymerized quantum dot matrix therein. Such tube design advantageously avoids, resists or inhibits cracking from such stresses which can allow oxygen into the tube. Oxygen may degrade quantum dots during periods of high light flux exposure. Accordingly, an optical component including a glass tube having a quantum dot matrix therein under oxygen-free conditions can improve the performance of a polymerized quantum dot-containing matrix disposed therein.

Embodiments are further provided for a display including an optical component taught herein. A container including quantum dots or a quantum dot formulation is also referred to herein as an optical component. According to certain aspects, the dimensions of a container can be selected depending upon the intended end-use application of the optical component. The examples of containers described herein are exemplary and are not intended to be limiting.

Embodiments are still further provided for a device (e.g., but not limited to, a light-emitting device) including an optical component taught herein.

Each of the claims set forth at the end of the present application are hereby incorporated into this Summary section by reference in its entirety.

The foregoing, and other aspects and embodiments described herein all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed. Other embodiments will be apparent to those skilled in the art from consideration of the specification and practice of the invention disclosed herein.

### BRIEF DESCRIPTION OF THE DRAWINGS

In the drawings:

FIGS. 1A, 1B and 1C are drawings of a tube of the present invention. FIG. 1A is a front view of a tube of the present invention. FIG. 1B is a top view of a tube of the present invention. FIG. 1C is a top front perspective view of a tube of the present invention.

FIG. 1D is a schematic of a system for filling one or more tubes or capillaries.

FIG. 1E is a schematic of a system for filling one or more tubes or capillaries.

FIG. 2 is a flow chart describing a capillary fill procedure.

FIG. 3 depicts a cross-section of a drawing of an example of an embodiment of a tube in accordance with the present invention.

FIG. 4 is a schematic of a system for maintaining and/or processing a quantum dot formulation.

FIG. 5 is a schematic of a system for maintaining and/or processing a quantum dot formulation.

FIG. 6 is a schematic of a system for maintaining and/or processing a quantum dot formulation.

FIG. 7 is a schematic of a system for maintaining and/or processing a quantum dot formulation.

FIG. 8 is an absorption spectrum of the core material (577 nm peak, 12 nm HWHM).

FIG. 9 is an absorption and emission spectrum of grCdSeCS-070 (Emission Peak: 626 nm; FWHM 26.6 nm).

FIG. 10 is an absorption spectrum of the core material (448 nm peak, 16 nm HWHM).

FIG. 11 is an absorbance and emission spectrum of ggCdSeCS-101 (522 nm emission, 35 nm FWHM)

FIG. 12 is an absorption spectrum of the core material (448 nm peak, 16 nm HWHM).

FIG. 13 is an absorption and emission spectrum of the final core/shell material (515 nm peak, 32 nm FWHM).

FIG. 14 is a schematic representation of a system for making quantum dot formulations substantially free of oxygen and substantially free of water.

FIG. 15 is a graph of reliability data.

FIG. 16 is a cross-sectional view of a testing unit described herein.

FIG. 17 is a graph of normalized lumens versus time for various oxygen concentrations.

FIG. 18 is a graph of delta (Δ) CIEₓ versus time for various oxygen concentrations.

FIG. 19 is a graph of delta (Δ) CIE_{y} versus time for various oxygen concentrations.

The attached figures are simplified representations presented for purposes of illustration only; the actual structures may differ in numerous respects, including, e.g., relative scale, etc.

For a better understanding to the present invention, together with other advantages and capabilities thereof, reference is made to the following disclosure and appended claims in connection with the above-described drawings.

### DETAILED DESCRIPTION OF THE INVENTION

Embodiments of the present invention are directed to a method of making a quantum dot formulation substantially free of oxygen and, optionally, substantially free of water. According to certain aspects quantum dots substantially free of oxygen and, optionally, substantially free of water and one or more components substantially free of oxygen and, optionally, substantially free of water are combined to form the quantum dot formulation substantially free of oxygen and, optionally, substantially free of water. The one or more components include components known to those of skill in the art of making quantum dot formulations.

In certain preferred embodiments, the quantum dot formulations include less than 1 ppm oxygen and less than 1 ppm water.

According to one aspect, the quantum dots are prepared in a manner that results in quantum dots being substantially free of oxygen. For example, quantum dots are grown, isolated from growth solution (e.g., via centrifugation), and redispersed under inert gas conditions or glove box environments where oxygen is present at less than 1 ppm. According to one aspect, the quantum dots are prepared in a manner that results in quantum dots being substantially free of water. According to one aspect, the quantum dots are prepared in a manner that results in a volume of quantum dots being substantially free of oxygen and substantially free of water.

According to an additional aspect, the one or more components are processed to remove oxygen from the one or more components. According to an additional aspect, the one or more components are processed to remove water from the one or more components. According to an additional aspect, the one or more components are processed to remove oxygen and water from the one or more components. According to this aspect, oxygen and/or water are removed from the one or more components prior to combining with the quantum dots. According to this aspect, oxygen and/or water are removed from each of the individual one or more components prior to combining with any other component or the quantum dots. According to this aspect, oxygen and water are removed from a mixture of two or more components prior to combination with any other component or the quantum dots.

According to one aspect, the one or more components can include a polymerizable component, a crosslinking agent, a scattering agent, a rheology modifier, a filler, a photoinitiator, or a thermal initiator. It is to be understood that other components used in making quantum dot formulations will become apparent to those of skill in the art based on the present disclosure. According to one aspect, the one or more components are cured or otherwise polymerized to form a matrix within which is dispersed the quantum dots. The matrix may be referred to herein as a host material.

According to certain aspects, methods of removing oxygen from solids or liquids known to those of skill in the art may be used to remove oxygen from the one or more components. Such methods of removing oxygen include vacuum methods, gas displacement methods including 1) placing the material in a low oxygen level environment such as a glove box (<1 ppm O₂) for 20+ minutes; 2) purging the material with an inert gas such as N₂ or more preferably Argon gas; 3) purging (reducing pressure/pulling vacuum) and backfilling the material/vessel containing the material with inert gas (e.g. N₂, Ar) for several cycles (3+); 4) subjecting the material to 3+ freeze, pump, thaw cycles (i.e. freeze the material in liquid nitrogen, place under reduced pressure/pull vacuum (e.g. ˜100 mTorr), back fill with inert gas, and then return the material to room temperature and repeat; and other methods known to those of skill in the art carried out at an appropriate temperature and for an appropriate period of time.

According to certain aspects, methods of removing water from solids or liquids known to those of skill in the art may be used to remove water from the one or more components. Such methods of removing water include vacuum methods, heating methods, molecular sieve methods, desiccator methods including 1) azeotroping off the water by dissolving the material in solvent (e.g. toluene, benzene, isopropanol, etc.) and then removing the solvent under reduced pressure (e.g. ˜100 mTorr); and 2) freeze drying the material (i.e. dissolve the material in benzene, freeze the mixture and then apply reduced pressure to the frozen mixture (e.g. ˜100 mTorr) and allow the system to return to room temperature naturally with no external heating while under reduced pressure (as the benzene/water in the mixture azeotropes off the material, the material is kept cold by the endothermic process) and other methods known to those of skill in the art carried out at an appropriate temperature and for an appropriate period of time. Exemplary methods and apparatuses include the use of molecular sieves, nitrogen purging, vacuum desiccation, oven heating, vacuum removal or a combination thereof.

According to certain aspects, containers used in the making of the quantum dots may be processed to reduce or eliminate oxygen or water that may be associated with the container. Such methods include purging the container with an inert gas such as nitrogen or heating the container at an elevated temperature to facilitate removal of water or both. According to certain aspects, containers used in the processing of the one or more components to remove oxygen and/or water may be processed to reduce or eliminate oxygen or water that may be associated with the container. Such methods include purging the container with an inert gas such as nitrogen or heating the container at an elevated temperature to facilitate removal of water or both.

According to certain aspects, oxygen may be present in a volume of quantum dots in an amount of less than about 10 parts per million (ppm), in an amount of less than about 5 ppm, in an amount of less than about 4 ppm, in an amount of less than about 3 ppm, in an amount of less than about 2 ppm, in an amount of less than about 1 ppm, in an amount of less than about 500 parts per billion (ppb), in an amount of less than about 300 parts per ppb or in an amount of less than about 100 ppb. According to certain aspects, water may be present in a volume of quantum dots in an amount of less than about 100 parts per million (ppm), in an amount of less than about 50 ppm, in an amount of less than about 10 ppm, in an amount of less than about 5 ppm, in an amount of less than about 4 ppm, in an amount of less than about 3 ppm, in an amount of less than about 2 ppm, or in an amount of less than about 1 ppm.

According to certain aspects, oxygen may be present in a volume of one or more components in an amount of less than about 10 parts per million (ppm), in an amount of less than about 5 ppm, in an amount of less than about 4 ppm, in an amount of less than about 3 ppm, in an amount of less than about 2 ppm, in an amount of less than about 1 ppm, in an amount of less than about 500 parts per billion (ppb), in an amount of less than about 300 parts per ppb or in an amount of less than about 100 ppb. According to certain aspects, water may be present in a volume of one or more components in an amount of less than about 100 parts per million (ppm), in an amount of less than about 50 ppm, in an amount of less than about 10 parts per million (ppm), in an amount of less than about 5 ppm, in an amount of less than about 4 ppm, in an amount of less than about 3 ppm, in an amount of less than about 2 ppm, in an amount of less than 1 ppm.

According to certain aspects, a quantum dot formulation substantially free of oxygen and, optionally, substantially free of water is provided by a combination of quantum dots substantially free of oxygen and, optionally, substantially free of water and one or more components substantially free of oxygen and, optionally, substantially free of water. According to certain aspects, oxygen may be present in the quantum dot formulation in an amount of less than about 10 parts per million (ppm), in an amount of less than about 5 ppm, in an amount of less than about 4 ppm, in an amount of less than about 3 ppm, in an amount of less than about 2 ppm, in an amount of less than about 1 ppm, in an amount of less than about 500 parts per billion (ppb), in an amount of less than about 300 parts per ppb or in an amount of less than about 100 ppb. According to certain aspects, water may be present in the quantum dot formulation in an amount of less than about 100 parts per million (ppm), in an amount of less than about 50 ppm, in an amount of less than about 10 parts per million (ppm), in an amount of less than about 5 ppm, in an amount of less than about 4 ppm, in an amount of less than about 3 ppm, in an amount of less than about 2 ppm, in an amount of less than 1 ppm.

According to certain aspects, the one or more components are added to the quantum dots. According to certain aspects, the quantum dots are added to at least one of the one or more components. According to certain aspects, the quantum dots are added to a plurality of components. According to certain aspects, the quantum dots are added to a mixture of the components. It is to be understood that the present invention includes a combination of the quantum dots and the one or more components to form a quantum dot formulation. The combination resulting in the quantum dot formulation may be achieved by adding quantum dots to components or adding components to quantum dots.

According to certain aspects, a preparation of components substantially free of oxygen and substantially free of water to be combined with quantum dots may be created within a controlled atmosphere, such as an inert atmosphere with little or no water vapor. An exemplary controlled atmosphere is provided by a commercially available dry box. According to certain aspects, a preparation of two or more components substantially free of oxygen and substantially free of water to be combined with quantum dots is created under an inert atmosphere with little or no water vapor, such as within a dry box. According to certain aspects, individual components substantially free of oxygen and substantially free of water are brought into the dry box. Thereafter, the individual components are combined, such as within a mixing vessel to create the preparation of components substantially free of oxygen and substantially free of water to be added to the quantum dots substantially free of oxygen and substantially free of water.

According to certain aspects, the preparation of components substantially free of oxygen and substantially free of water is combined with the quantum dots substantially free of oxygen and substantially free of water in a suitable reactor vessel known to those of skill in the art. A suitable reactor vessel may include a mixing element and has an inert atmosphere with little or no water vapor. According to certain aspects, the preparation of components substantially free of oxygen and substantially free of water is removed from the dry box into a suitable reactor vessel and the reactor vessel is processed to eliminate or reduce oxygen and/or water vapor from the reactor vessel. According to one aspect, quantum dots substantially free of oxygen and substantially free of water are added to the reactor vessel to create a quantum dot formulation substantially free of oxygen and substantially free of water. According to certain aspects, quantum dots components substantially free of oxygen and substantially free of water are added to the reactor vessel. The preparation of components substantially free of oxygen and substantially free of water is introduced into the reactor vessel to create a quantum dot formulation substantially free of oxygen and substantially free of water.

According to certain aspects, the quantum dot formulation substantially free of oxygen and substantially free of water is introduced into a vessel under oxygen free and water free conditions such as a dry glove box where oxygen is present in an amount of less than about 1 ppm. The vessel may be processed to reduce or eliminate oxygen or water that may be associated with the vessel. Such methods include purging the vessel with an inert gas such as nitrogen or heating the vessel at an elevated temperature to facilitate removal of water or both.

According to certain aspects, the vessel may then be sealed to prevent oxygen and/or water vapor from entering the vessel. Methods of sealing, such as hermetically sealing, vessels including quantum dots are known to those of skill in the art.

According to certain aspects, the sealed vessel including the quantum dot formulation substantially free of oxygen and substantially free of water is then subject to conditions sufficient to cure the quantum dot formulation or otherwise polymerize the quantum dot formulation within the vessel to produce a matrix including the quantum dots. Such conditions include light of certain wavelength or heat or other conditions known to those of skill in the art useful to cure quantum dot formulations or otherwise polymerize quantum dot formulations into a matrix. According to one aspect, the vessel must be sealed before being subjected to conditions sufficient to cure the quantum dot formulation or otherwise polymerize the quantum dot formulation within the vessel to produce a matrix including the quantum dots. According to one aspect, the seal may be a temporary seal during polymerization, such as UV-initiated free-radical polymerizations. According to one embodiment, the seal prevents oxygen and water ingress to the quantum dot formulation during the time of cure such as during the time the quantum dot formulation is exposed to light for curing. The cured quantum dot matrix is then hermetically sealed within the vessel. According to one aspect, the head space or open space within the vessel is kept as small as possible to reduce the amount of residual oxygen in the vessel.

The quantum dot-containing vessel can be in combination with a stimulating light to produce light of one or more wavelengths including, e.g., trichromatic white light which can be used in various lighting applications such as back light units for liquid crystal displays. The vessel is preferably light transmissive. The vessel described herein in combination with the quantum dots is also referred to herein as an optical component.

Embodiments of the invention include an optical material comprising a composition taught herein.

Embodiments of the invention further include an optical component comprising a composition in accordance with the present invention.

An optical component can further include a structural member that supports or contains the composition. Such structural member can have a variety of different shapes or configurations. For example, it can be planar, curved, convex, concave, hollow, linear, circular, square, rectangular, oval, spherical, cylindrical, or any other shape or configuration that is appropriate based on the intended end-use application and design. An example of a common structural component is a substrate such as a plate-like member or a tubular—like structural member.

An optical material can be disposed on or over a surface of a structural member.

In certain embodiments, the optical component further includes a substrate having a surface on which the optical material is disposed. In certain embodiments, the composition is fully encapsulated between opposing substrates that are sealed together by a seal. In certain embodiments, one or both of the substrates comprise glass.

In certain embodiments, the seal comprises an edge or perimeter seal. In certain embodiments, the seal comprises barrier material. In certain embodiments, the seal comprises an oxygen barrier. In certain embodiments, the seal comprises a water barrier. In certain embodiments, the seal comprises an oxygen and water barrier. In certain embodiments, the seal is substantially impervious to water and/or oxygen.

In certain embodiments, the optical material is encapsulated by a barrier material that is substantially impervious to oxygen. In certain embodiments, the optical material is encapsulated by a material that is substantially impervious to moisture (e.g., water). In certain embodiments, the optical material is encapsulated by a material that is substantially impervious to oxygen and moisture. In certain embodiments, for example, the optical material can be sandwiched between substrates. In certain embodiments, one or both of the substrates can comprise glass plates. In certain embodiments, for example, the optical material can be sandwiched between a substrate (e.g., a glass plate) and a barrier film. In certain embodiments, the optical material can be sandwiched between two barrier films or coatings.

In certain embodiments, the optical material is fully encapsulated. In certain embodiments, for example, the optical material can be sandwiched between substrates (e.g., glass plates) that are sealed by a perimeter seal. In certain embodiments, for example, the optical material can be disposed on a substrate (e.g., a glass support) and fully covered by barrier film. In certain embodiments, for example, the optical material can be disposed on a substrate (e.g., a glass support) and fully covered by protective coating. In certain embodiments, the optical material can be sandwiched between two barrier films or coatings that are sealed by a perimeter seal.

Example of suitable barrier films or coatings include, without limitation, a hard metal oxide coating, a thin glass layer, and Barix coating materials available from Vitex Systems, Inc. Other barrier films or coating can be readily ascertained by one of ordinary skill in the art.

In certain embodiments, more than one barrier film or coating can be used to encapsulate the optical material.

In another example, an optical component can comprise a composition included within a structural member. For example, the composition can be included in a hollow or cavity portion of a tubular-like structural member (e.g., a tube, hollow capillary, hollow fiber, etc.) that can be open at either or both ends. Preferably open end(s) of the member are hermetically sealed after the composition is included therein.

Other designs, configurations, and combinations of barrier materials and/or structural members comprising barrier materials can be included in an optical component in which the optical material is at least partially encapsulated. Such designs, configurations, and combinations can be selected based on the intended end-use application and design.

A structure member is preferably optically transparent to permit light to pass into and/or out of the composition that it may encapsulate.

The configuration and dimensions of an optical component can be selected based on the intended end-use application and design.

An optical component comprising a structural member in which the composition is hermetically contained can be preferred.

An optical component can further include one or more barrier materials which can be selected to protect the composition from environmental effects (e.g., oxygen and/or water).

According to certain aspects of the present invention, a container may be a vessel, tube, capillary or other container known to those of skill in the art. According to one aspect, the container is hollow and can be fashioned from various light transmissive materials including glass.

According to one aspect, the container has a stress-resistant or stress-tolerant configuration and exhibits stress-resistant or stress-tolerant properties when subjected to stresses from polymerizing a formulation therein or heating the container with the polymerized formulation therein. According to this aspect, a glass tube with such stress-resistant or stress tolerant properties avoids, resists or inhibits cracking due to stresses during manufacture of an optical component including the glass tube, manufacture and/or use in a display device, and during cycling of the display device. According to an additional aspect, a glass tube with such stress-resistant or stress tolerant properties having a polymer matrix therein that includes a material that provides ductility avoids, resists or inhibits cracking due to stresses during manufacture of an optical component including the glass tube, manufacture and/or use in a display device, and during cycling of the display device. The tube has dimensions suitable for application within a display device. The glass tube may include borosilicates. The glass tube may include soda lime. The glass tube may include borosilicates and soda lime. According to one aspect, borosilicates are preferred materials for glass tubes of the present invention.

A tube within the scope of the present invention can have a length of between about 50 mm and about 1500 mm, between about 500 mm and about 1500 mm or between about 50 mm and 1200 mm and usually has a length comparable to a light guide within a display device. A tube within the scope of the present invention can have a wall thickness sufficient to withstand stresses due the polymerization of the quantum dot matrix and heating of the tube and matrix combination. Suitable wall thicknesses include a thickness between about 250 microns and about 700 microns, about 275 microns and about 650 microns, about 300 microns and about 500 microns, about 325 microns and about 475 microns, about 350 microns and about 450 microns, and about 350 microns and about 650 microns and any value or range in between whether overlapping or not. Other lengths and/or thicknesses may be used based on the intended end-use application.

According to certain embodiments, the tube has a cross-sectional wall configuration which produces stress-resistant or stress tolerant properties. Configurations may include a circle, a rounded square, an oval, a racetrack configuration having parallel sides with full radius ends, and the like. According to certain aspects, the cross-sectional configuration has a wall to wall outer major dimension between about 0.5 mm and about 4.0 mm and a wall to wall inner minor dimension between about 0.15 mm and about 3.3 mm.

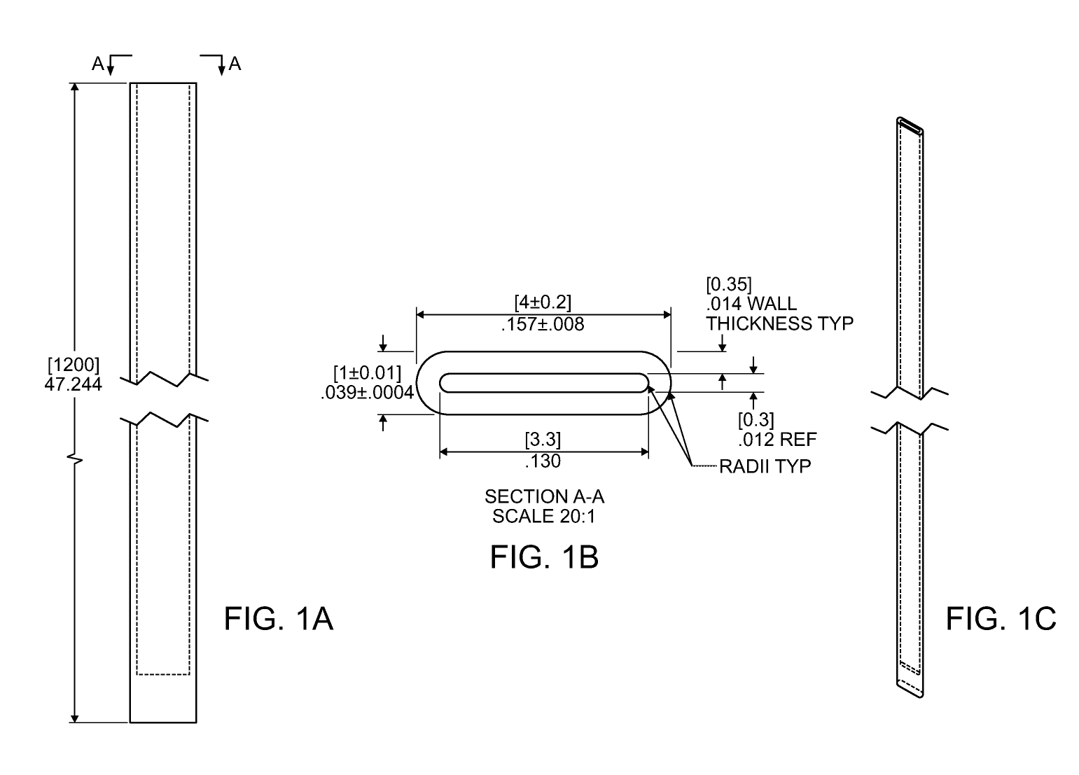

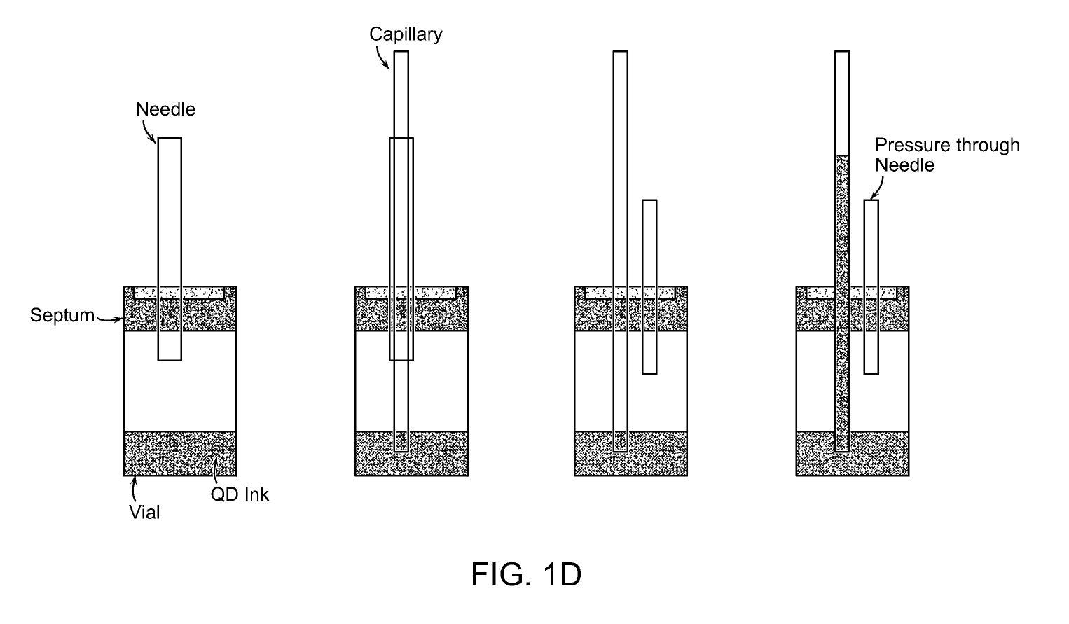

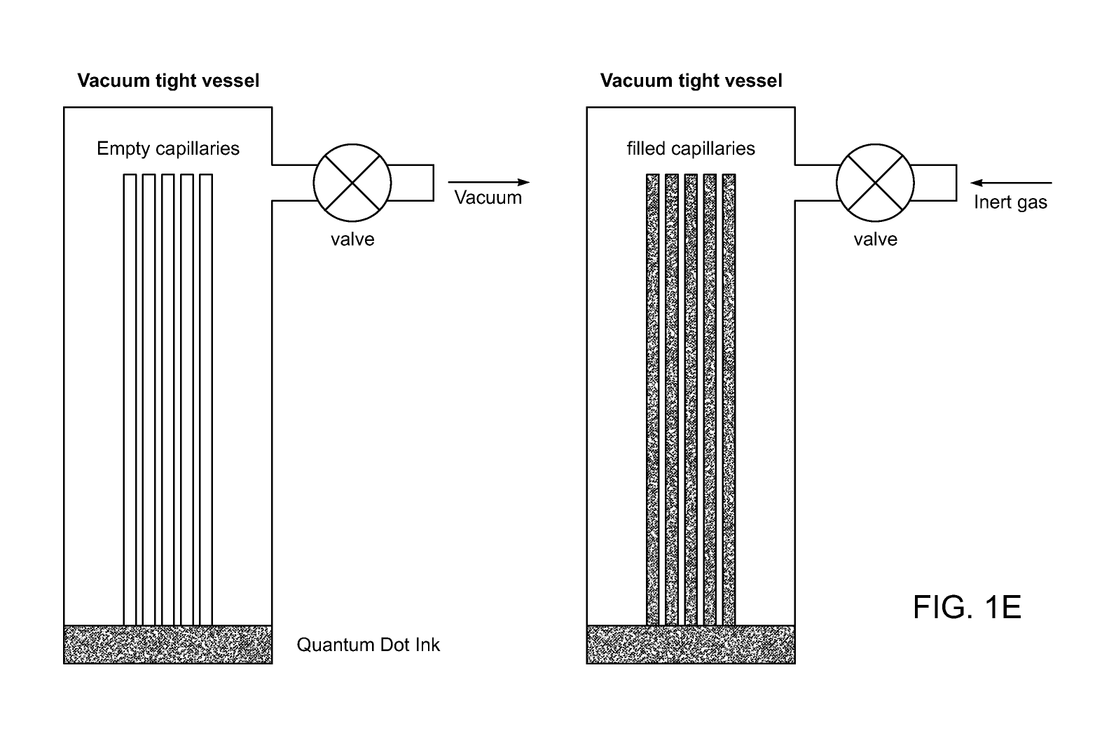

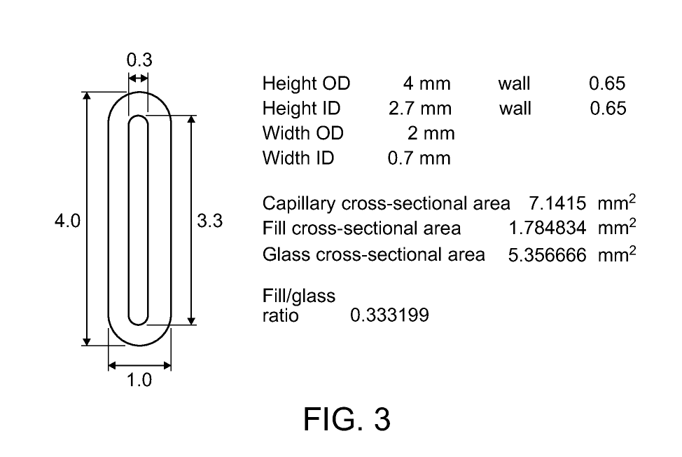

FIG. 1B depicts in schematic form a tube having a cross-sectional wall design in the configuration of a racetrack. According to this aspect, the wall of the tube includes a first full semicircle or radius end and a second full semicircle or radius end. The first full radius end and the second full radius end are connected by first and second substantially parallel walls. An exemplary tube having a cross-sectional configuration of a racetrack is characterized as being stress-resistant or stress-tolerant to the stresses or load on the tube due to polymerization and curing of a polymerizable quantum dot formulation within the tube and additional stresses from heating the tube with the polymerized quantum dot matrix therein. Such an exemplary tube is referred to herein as a stress-resistant tube or stress-tolerant tube. An exemplary tube is depicted in FIG. 3.

According to one aspect, the walls are straight or flat and provide a consistent or uniform path length through the tube and accordingly through the quantum dot matrix therein through which photons from an LED may pass. The substantially parallel and straight walls also advantageously provide a flat face to couple the tube to a corresponding flat end of a light guide plate of a back light unit. According to one aspect, the tube with the race track configuration has a cross-sectional diameter of between about 0.5 mm and about 5.0 mm in the elongate direction (major dimension) and between about 0.15 mm and about 3.3 mm in the width direction (minor dimension). One example of a suitable cross sectional diameter is about 4 mm in the elongate direction by about 1 mm in the width direction. According to one aspect, the full radius ends advantageously bear higher loads than square cornered tubes.

As can be seen in FIG. 1B, the tube has a uniform wall thickness. Such a wall thickness can be within the range of between about 60 and about 700 microns. However, it is to be understood that the wall thickness may be uniform or nonuniform, i.e. of varying thickness. For example, the full radius ends of the tube may be thicker than the straight wall portions so as to provide greater stability. One exemplary wall thickness is between about 310 microns and about 390 microns, such as about 315 microns or about 380 microns. Such a wall thickness advantageously inhibits breakage of the tube during processing. As shown in FIG. 1B, the walls define an interior volume into which quantum dots are to be provided in the form of a matrix. The interior volume is dependent upon the dimensions of the stress-resistant tube. However, suitable volumes include between about 0.0015 ml and about 2.0 ml. In addition, stress-resistant tubes of the present invention have a ratio of the cross-sectional area of the matrix to the cross-sectional area of the wall of less than or equal to about 0.35. An exemplary ratio characteristic of a stress-resistant tube is about 0.35.

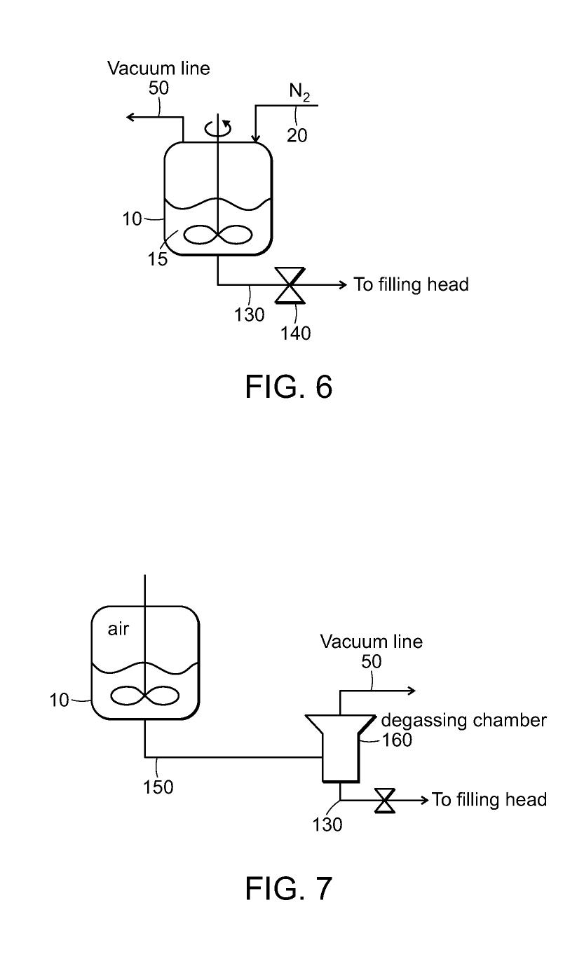

In addition to having full radius ends, capillaries of the present invention preferably have a predetermined ratio of glass wall thickness to the volume of internal matrix. Control of such ratio can allow the capillary to bear stress loads set up by both the shrinkage of the matrix monomers upon polymerization as well as the differential expansion and contraction of the polymer/glass system on thermal cycling. For example, for a capillary containing a cross-linked LMA/dodecyldimethacrylate matrix system (e.g., described elsewhere herein), a matrix cross sectional area to glass cross sectional area ratio below 0.35 can be preferred, although ratios as high as 0.7 can also be beneficial for capillaries prepared from direct drawn glass. FIG. 6 depicts a cross-section of a drawing of an example of an embodiment of a tube in accordance with the present invention showing dimensions related to this ratio.

According to one aspect, the length of the tube is selected based on the length of the side of the light guide plate of the backlight unit along which it is positioned. Such lengths include between about 50 mm and about 1500 mm with the optically active area spanning substantially the entire length of the tube. An exemplary length is about 1100 mm or about 1200 mm. It is to be understood that the length of the tube can be shorter than, equal to, or longer than the length of the light guide plate.

According to one aspect, both ends of the glass tube may be sealed. The seal can be of any size or length. One exemplary dimension is that the distance from the end of the capillary to the beginning of the optically active area is between about 2 mm to about 8 mm, with about 3 mm or 5 mm being exemplary. Sealing methods and materials are known to those of skill in the art and include glass seal (e.g., via flame sealing), epoxy, silicone, acrylic, light or heat curable polymers and metal. A commercially available sealing material is CERASOLZER available from MBR Electronics GmbH (Switzerland). Suitable metals or metal solders useful as sealing materials to provide a hermetic seal and good glass adhesion include indium, indium tin, and indium tin and bismuth alloys, as well as eutetics of tin and bismuth. One exemplary solder includes indium #316 alloy commercially available from McMaster-Carr. Sealing using solders may be accomplished using conventional soldering irons or ultrasonic soldering baths known to those of skill in the art. Ultrasonic methods provide fluxless sealing using indium solder in particular. Seals include caps of the sealing materials having dimensions suitable to fit over and be secured to an end of the tube. According to one embodiment, one end of the tube is sealed with glass and the other end is sealed with epoxy. According to one aspect, the glass tube with a quantum dot matrix therein is hermetically sealed. Examples of sealing techniques include but are not limited to, (1) contacting an open end of a tube with an epoxy, (2) drawing the epoxy into the open end due to shrinkage action of a curing resin, or (3) covering the open end with a glass adhering metal such as a glass adhering solder or other glass adhering material, and (4) melting the open end by heating the glass above the melting point of the glass and pinching the walls together to close the opening to form a molten glass hermetic seal.

In certain embodiments, for example, a tube is filled with a liquid quantum dot formulation substantially free of oxygen and, optionally, substantially free of water under oxygen free and, optionally, water free conditions, the end or ends of the tube are sealed under oxygen-free and, optionally, water free conditions and the liquid quantum dot formulation is UV cured. The filling procedures described herein may be carried out at room temperature such as between about 20° C. to about 25° C. An oxygen-free condition refers to a condition or an atmosphere where oxygen is substantially absent, essentially absent or completely absent. An oxygen-free condition can be provided by a nitrogen atmosphere or other inert gas atmosphere where oxygen is substantially absent, essentially absent or completely absent. In addition, an oxygen-free condition can be provided by placing the quantum dot formulation under vacuum. A water-free condition refers to a condition or an atmosphere where water is substantially absent, essentially absent or completely absent. A water-free condition can be provided by a dry nitrogen atmosphere or other dry inert gas atmosphere where water is absent or substantially absent. In addition, a water-free condition can be provided by placing the quantum dot formulation under vacuum.

According to one aspect, a stress-resistant tube, such as a borosilicate glass tube having a configuration described herein, is filled under oxygen free and, optionally, water free conditions with a quantum dot formulation. Accordingly, the environment within the tube and/or the quantum dot formulation within the tube is substantially free, essentially free or completely free of oxygen and, optionally, substantially free, essentially free or completely free of water. Glass vessels, tubes or capillaries are maintained under conditions of suitable time, pressure and temperature sufficient to dry the glass vessels, tubes or capillaries. A quantum dot ink formulation is maintained in a quantum dot ink vessel under nitrogen. Dried capillaries with one end open are placed into a vacuum fill vessel with an open end down into quantum dot ink. The quantum dot ink vessel is connected to the vacuum fill vessel via tubing and valves such that ink is able to flow from the quantum dot ink vessel to the vacuum fill vessel by applying pressure differentials. The pressure within the vacuum fill vessel is reduced to less than 200 mtorr and then repressurized with nitrogen. Quantum dot ink is admitted into the vacuum fill vessel by pressurization of the quantum dot ink vessel and the capillaries are allowed to fill under oxygen free conditions. Alternatively, the vacuum fill vessel can be evacuated thereby drawing the fluid up into the capillaries. After the capillaries are filled, the system is bled to atmospheric pressure. The exterior of the capillaries are then cleaned using toluene.

According to an additional aspect, a pressure differential can be used to transfer an amount of quantum dot ink from one vessel to another. For example, and with reference to FIG. 1D, an amount of quantum dot ink can be contained in a vial or well container capped with a septum. A larger gauge needle is then introduced through the septum and into the vial. A capillary is then introduced into the vial through the needle and into the quantum ink at the bottom of the vial. The needle is then removed and the septum closes around the capillary. A pressurizing needle attached to a syringe is then introduced through the septum. A dry inert gas is then introduced into the vial using the syringe which increases the pressure in the vial, which in turn forces the quantum dot ink into the capillary. Thereafter, the filled capillary is removed from the quantum ink supply and the vial and sealed at each end. Following removal, the ink included in the sealed capillary is cured. Alternatively, the ink can be cured prior to sealing.

In another embodiment, a tube can be filled by application of vacuum to draw the ink into the tube. An example of a set-up for filling a tube by application of vacuum is shown in FIG. 1E. A tube, such as a capillary tube, is sealed at one end and placed open end down in an airtight vessel. Numerous tubes can be loaded simultaneously into the same vessel. To this vessel is added enough quantum dot ink to submerge the open ends of the tubes and the vessel is sealed. Vacuum is applied and the pressure of the system is reduced to between about 1 millitorr to about 1000 millitorr. The vessel is then repressurized with nitrogen causing the capillaries to fill. A slight overpressure of gas such as between 0-60 psi, speeds filling of the tubes. The tubes are then removed from the well, cleaned and then sealed to provide a tube with a quantum dot formulation therein and having a substantially oxygen free and substantially water free environment within the tube.

According to an additional embodiment, tubes can be filled with a quantum dot formulation using gravity where the quantum dot formulation is simply poured or pipetted or otherwise injected into an open upper portion of the tube which is maintained under oxygen-free and, optionally, water-free conditions and the quantum dot formulation flows into the lower portion of the tube under the influence of gravity. The tube can then be sealed providing a sealed tube with a quantum dot formulation therein and with a substantially oxygen free and, optionally, substantially water-free environment within the tube.

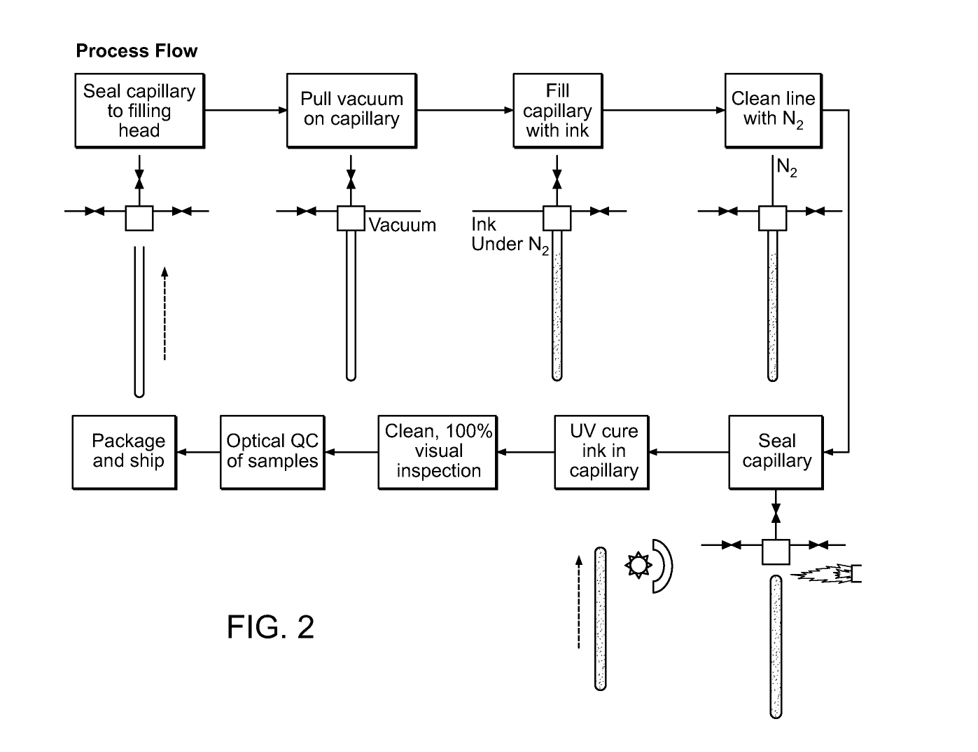

According to an additional embodiment with reference to FIG. 2, a capillary with one end sealed is connected to a filling or manifold head capable of docking with the capillary and switching between vacuum and ink fill. The capillary is evacuated by a vacuum having a vacuum capability of less than 200 mTorr. Quantum dot ink under nitrogen pressure is then filled into the capillary. The quantum dot ink or formulation is under an oxygen-free and, optionally, water-free condition, i.e., oxygen and, optionally, water are substantially absent, essentially absent or completely absent. The lines and filling head are flushed with nitrogen. The capillary is held under an atmosphere of nitrogen or vacuum and the end sealed, such as by melting the capillary end and sealing, for example by a capillary sealing system. The ink may then be cured in the capillary using UV light in a UV curing apparatus for curing quantum dot ink.

In certain embodiments, for example, the quantum dot formulation substantially free of oxygen and substantially free of water within the vessel or tube or capillary can be cured with an H or D bulb emitting 900-1000 mjoules/cm² with a total dosage over about 1 to about 5 minutes. Alternatively, curing can be accomplished using a Dymax 500EC UV Curing Flood system equipped with a mercury UVB bulb. In such case, a lamp intensity (measured as 33 mW/cm² at a distance of about 7″ from the lamp housing) can be effective, with the capillary being cured for 10-15 seconds on each side while being kept at a distance of 7 inches from the lamp housing. After curing, the edges of the capillary can be sealed thereby providing a cured quantum dot formulation under oxygen free and water free conditions. Alternatively, the vessel or tube or capillary is sealed, such as hermetically sealed, and then cured with an H or D bulb emitting 900-1000 mjoules/cm² with a total dosage over about 1 to about 5 minutes. Alternatively, curing can be accomplished using a Dymax 500EC UV Curing Flood system equipped with a mercury UVB bulb. In such case, a lamp intensity (measured as 33 mW/cm² at a distance of about 7″ from the lamp housing) can be effective, with the capillary being cured for 10-15 seconds on each side while being kept at a distance of 7 inches from the lamp housing.

In certain embodiments relating to a temporary seal, sealing can comprise using an optical adhesive, a hot glue or silicone to seal one or both ends or edges of the capillary. For example, a drop of optical adhesive can be placed on each edge of the capillary and cured. An example of an optical adhesive includes, but is not limited to, NOA-68T obtainable from Norland Optics. For example, a drop of such adhesive can be placed on each edge of the capillary and cured (e.g., for 20 seconds with a Rolence Enterprise Model Q-Lux-UV lamp).

In certain embodiments, sealing can comprise using glass to seal one or both ends or edges of the capillary. This can be done by briefly bringing a capillary filled with cured quantum dot ink into brief contact with an oxygen/Mapp gas flame until the glass flows and seals the end. Oxygen-hydrogen flames may be used as well as any other mixed gas flame. The heat may also be supplied by laser eliminating the need for an open flame. In certain embodiments, both ends of a capillary filled with uncured quantum dot ink substantially free of oxygen and substantially free of water can be sealed, allowing the ink to then be photocured in the sealed capillary.

In certain embodiments, the capillary is hermetically sealed, i.e., impervious to gases and moisture, thereby providing a sealed capillary where oxygen and water is substantially or completely absent within the sealed capillary.

In certain embodiments, the capillary is pseudo-hermetically sealed, i.e., at least partially impervious to gases and moisture.

Other suitable techniques can be used for sealing the ends or edges of the capillary.

In certain aspects and embodiments of the inventions taught herein, the stress-resistant tube including the cured quantum dot formulation (optical material) may optionally be exposed to light flux for a period of time sufficient to increase the photoluminescent efficiency of the optical material.

In certain embodiments, the optical material is exposed to light and heat for a period of time sufficient to increase the photoluminescent efficiency of the optical material.

In preferred certain embodiments, the exposure to light or light and heat is continued for a period of time until the photoluminescent efficiency reaches a substantially constant value.

In one embodiment, for example, after the optic is filled with quantum dot containing ink under oxygen free conditions, cured, and sealed (regardless of the order in which the curing and sealing steps are conducted), the optic is exposed, to 25-35 mW/cm² light flux with a wavelength in a range from about 365 nm to about 470 nm, while at a temperature of in a range from about 25° C. to about 80° C., for a period of time sufficient to increase the photoluminescent efficiency of the ink. In one embodiment, for example, the light has a wavelength of about 450 nm, the light flux is 30 mW/cm², the temperature is 80° C., and the exposure time is 3 hours. Alternatively, the quantum dot containing ink can be cured within the tube before sealing one or both ends of the tube.

According to one aspect of the present invention, a polymerizable composition including quantum dots is provided. Quantum dots may be present in the polymerizable composition in an amount from about 0.05% w/w to about 5.0% w/w. According to one aspect, the polymerizable composition is photopolymerizable. The polymerizable composition is substantially free of oxygen and, optionally, substantially free of water. The polymerizable composition is in the form of a fluid which can be placed within the tube under oxygen-free and, optionally, water-free conditions and then one or both ends sealed with the tube being hermetically sealed to avoid oxygen and, optionally, water being within the tube. The polymerizable composition is then subjected to light of sufficient intensity and for a period of time sufficient to polymerize the polymerizable composition. The period of time can range between about 10 seconds to about 6 minutes or between about 1 minute to about 6 minutes.

According to one aspect, the polymerizable composition avoids, resists or inhibits yellowing when in the form of a matrix, such as a polymerized matrix. A matrix in which quantum dots are dispersed may be referred to as a host material. Host materials include polymeric and non-polymeric materials that are at least partially transparent, and preferably fully transparent, to preselected wavelengths of light.

According to an additional aspect, the polymerizable composition is selected so as to provide sufficient ductility to the polymerized matrix. Ductility is advantageous in relieving the stresses on the tube that occur during polymer shrinkage when the polymer matrix is cured. Suitable polymerizable compositions act as solvents for the quantum dots and so combinations of polymerizable compositions can be selected based on solvent properties for various quantum dots.

Polymerizable compositions include monomers and oligomers and polymers and mixtures thereof. Exemplary monomers include lauryl methacrylate, norbornyl methacrylate, Ebecyl 150 (Cytec), CD590 (Cytec), silicones, thermally cured silicones, inorganic sol-gel materials, such as ZnO, SnO₁, SnO₂, ZrO₂ and the like. Polymerizable materials can be present in the polymerizable formulation in an amount greater than 50 weight percent. Examples include amounts in a range greater than 50 to about 99.5 weight percent, greater than 50 to about 98 weight percent, greater than 50 to about 95 weight percent, from about 80 to about 99.5 weight percent, from about 90 to about 99.95 weight percent, from about 95 to about 99.95 weight percent. Other amounts outside these examples may also be determined to be useful or desirable.

Exemplary polymerizable compositions can further include one or more of a crosslinking agent, a scattering agent, a rheology modifier, a filler, a photoinitiator, or a thermal initiator.

Suitable crosslinking agents include ethylene glycol dimethacrylate, Ebecyl 150, dodecyldimethacrylate, dodecyldiacrylate and the like. Crosslinking agents can be present in the polymerizable formulation in an amount between about 0.5 wt % and about 3.0 wt %. Crosslinking agents are generally added, for example in an amount of 1% w/w, to improve stability and strength of a polymer matrix which helps avoid cracking of the matrix due to shrinkage upon curing of the matrix.

Suitable scattering agents include TiO₂, alumina, barium sulfate, PTFE, barium titanate and the like. Scattering agents can be present in the polymerizable formulation in an amount between about 0.05 wt % and about 1.0 wt %. Scattering agents are generally added, for example in a preferred amount of about 0.15% w/w, to promote outcoupling of emitted light.

Suitable rheology modifiers (thixotropes) include fumed silica commercially available from Cabot Corporation such as TS-720 treated fumed silica, treated silica commercially available from Cabot Corporation such as TS720, TS500, TS530, TS610 and hydrophilic silica such as M5 and EHS commercially available from Cabot Corporation. Rheology modifiers can be present in the polymerizable formulation in an amount between about 0.5% w/w to about 12% w/w. Rheology modifiers or thixotropes act to lower the shrinkage of the matrix resin and help prevent cracking. Hydrophobic rheology modifiers disperse more easily and build viscosity at higher loadings allowing for more filler content and less shrinkage to the point where the formulation becomes too viscous to fill the tube. Rheology modifiers such as fumed silica also provide higher EQE and help to prevent settling of TiO₂ on the surface of the tube before polymerization has taken place.

Suitable fillers include silica, fumed silica, precipitated silica, glass beads, PMMA beads and the like. Fillers can be present in the polymerizable formulation in an amount between about 0.01% and about 60%, about 0.01% and about 50%, about 0.01% and about 40%, about 0.01% and about 30%, about 0.01% and about 20% and any value or range in between whether overlapping or not.

Suitable photoinitiators include Irgacure 2022, KTO-46 (Lambert), Esacure 1 (Lambert) and the like. Photoinitiators can be present in the polymerizable formulation in an amount between about 0.1% w/w to about 5% w/w. Photoinitiators generally help to sensitize the polymerizable composition to UV light for photopolymerization.

Suitable thermal initiators include 2,2′-azobis(2-methylpropionitrile, lauryl peroxide, di-tert butyl peroxide, benzoyl peroxide and the like.

According to additional aspects, quantum dots are nanometer sized particles that can have optical properties arising from quantum confinement. The particular composition(s), structure, and/or size of a quantum dot can be selected to achieve the desired wavelength of light to be emitted from the quantum dot upon stimulation with a particular excitation source. In essence, quantum dots may be tuned to emit light across the visible spectrum by changing their size. See C. B. Murray, C. R. Kagan, and M. G. Bawendi, Annual Review of Material Sci., 2000, 30: 545-610 hereby incorporated by reference in its entirety.

Quantum dots can have an average particle size in a range from about 1 to about 1000 nanometers (nm), and preferably in a range from about 1 to about 100 nm. In certain embodiments, quantum dots have an average particle size in a range from about 1 to about 20 nm (e.g., such as about 5, 6, 7, 8, 9, 10, 11, 12, 13, 14, 15, 16, 17, 18, 19, or 20 nm). In certain embodiments, quantum dots have an average particle size in a range from about 1 to about 10 nm. Quantum dots can have an average diameter less than about 150 Angstroms (\acute{Å}). In certain embodiments, quantum dots having an average diameter in a range from about 12 to about 150 \acute{Å} can be particularly desirable. However, depending upon the composition, structure, and desired emission wavelength of the quantum dot, the average diameter may be outside of these ranges.

Preferably, a quantum dot comprises a semiconductor nanocrystal. In certain embodiments, a semiconductor nanocrystal has an average particle size in a range from about 1 to about 20 nm, and preferably from about 1 to about 10 nm. However, depending upon the composition, structure, and desired emission wavelength of the quantum dot, the average diameter may be outside of these ranges.

A quantum dot can comprise one or more semiconductor materials.

Examples of semiconductor materials that can be included in a quantum dot (including, e.g., semiconductor nanocrystal) include, but are not limited to, a Group IV element, a Group II-VI compound, a Group II-V compound, a Group III-VI compound, a Group III-V compound, a Group IV-VI compound, a Group I-III-VI compound, a Group II-IV-VI compound, a Group II-IV-V compound, an alloy including any of the foregoing, and/or a mixture including any of the foregoing, including ternary and quaternary mixtures or alloys. A non-limiting list of examples include ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

In certain embodiments, quantum dots can comprise a core comprising one or more semiconductor materials and a shell comprising one or more semiconductor materials, wherein the shell is disposed over at least a portion, and preferably all, of the outer surface of the core. A quantum dot including a core and shell is also referred to as a “core/shell” structure.

For example, a quantum dot can include a core having the formula MX, where M is cadmium, zinc, magnesium, mercury, aluminum, gallium, indium, thallium, or mixtures thereof, and X is oxygen, sulfur, selenium, tellurium, nitrogen, phosphorus, arsenic, antimony, or mixtures thereof. Examples of materials suitable for use as quantum dot cores include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

A shell can be a semiconductor material having a composition that is the same as or different from the composition of the core. The shell can comprise an overcoat including one or more semiconductor materials on a surface of the core. Examples of semiconductor materials that can be included in a shell include, but are not limited to, a Group IV element, a Group II-VI compound, a Group II-V compound, a Group III-VI compound, a Group III-V compound, a Group IV-VI compound, a Group I-III-VI compound, a Group II-IV-VI compound, a Group II-IV-V compound, alloys including any of the foregoing, and/or mixtures including any of the foregoing, including ternary and quaternary mixtures or alloys. Examples include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing. For example, ZnS, ZnSe or CdS overcoatings can be grown on CdSe or CdTe semiconductor nanocrystals.

In a core/shell quantum dot, the shell or overcoating may comprise one or more layers. The overcoating can comprise at least one semiconductor material which is the same as or different from the composition of the core. Preferably, the overcoating has a thickness from about one to about ten monolayers. An overcoating can also have a thickness greater than ten monolayers. In certain embodiments, more than one overcoating can be included on a core.

In certain embodiments, the surrounding “shell” material can have a band gap greater than the band gap of the core material. In certain other embodiments, the surrounding shell material can have a band gap less than the band gap of the core material.

In certain embodiments, the shell can be chosen so as to have an atomic spacing close to that of the “core” substrate. In certain other embodiments, the shell and core materials can have the same crystal structure.

Examples of quantum dot (e.g., semiconductor nanocrystal) (core)shell materials include, without limitation: red (e.g., (CdSe)CdZnS (core)shell), green (e.g., (CdZnSe)CdZnS (core)shell, etc.), and blue (e.g., (CdS)CdZnS (core)shell.

Quantum dots can have various shapes, including, but not limited to, sphere, rod, disk, other shapes, and mixtures of various shaped particles.

One example of a method of manufacturing a quantum dot (including, for example, but not limited to, a semiconductor nanocrystal) is a colloidal growth process. Colloidal growth occurs by injection an M donor and an X donor into a hot coordinating solvent. One example of a preferred method for preparing monodisperse quantum dots comprises pyrolysis of organometallic reagents, such as dimethyl cadmium, injected into a hot, coordinating solvent. This permits discrete nucleation and results in the controlled growth of macroscopic quantities of quantum dots. The injection produces a nucleus that can be grown in a controlled manner to form a quantum dot. The reaction mixture can be gently heated to grow and anneal the quantum dot. Both the average size and the size distribution of the quantum dots in a sample are dependent on the growth temperature. The growth temperature for maintaining steady growth increases with increasing average crystal size. Resulting quantum dots are members of a population of quantum dots. As a result of the discrete nucleation and controlled growth, the population of quantum dots that can be obtained has a narrow, monodisperse distribution of diameters. The monodisperse distribution of diameters can also be referred to as a size. Preferably, a monodisperse population of particles includes a population of particles wherein at least about 60% of the particles in the population fall within a specified particle size range. A population of monodisperse particles preferably deviate less than 15% rms (root-mean-square) in diameter and more preferably less than 10% rms and most preferably less than 5%.

An example of an overcoating process is described, for example, in U.S. Pat. No. 6,322,901. By adjusting the temperature of the reaction mixture during overcoating and monitoring the absorption spectrum of the core, overcoated materials having high emission quantum efficiencies and narrow size distributions can be obtained.

The narrow size distribution of the quantum dots (including, e.g., semiconductor nanocrystals) allows the possibility of light emission in narrow spectral widths. Monodisperse semiconductor nanocrystals have been described in detail in Murray et al. (J. Am. Chem. Soc., 115.8706 (1993) which is hereby incorporated herein by reference in its entirety.

The process of controlled growth and annealing of the quantum dots in the coordinating solvent that follows nucleation can also result in uniform surface derivatization and regular core structures. As the size distribution sharpens, the temperature can be raised to maintain steady growth. By adding more M donor or X donor, the growth period can be shortened. The M donor can be an inorganic compound, an organometallic compound, or elemental metal. For example, an M donor can comprise cadmium, zinc, magnesium, mercury, aluminum, gallium, indium or thallium, and the X donor can comprise a compound capable of reacting with the M donor to form a material with the general formula MX. The X donor can comprise a chalcogenide donor or a pnictide donor, such as a phosphine chalcogenide, a bis(silyl)chalcogenide, dioxygen, an ammonium salt, or a tris(silyl)pnictide. Suitable X donors include, for example, but are not limited to, dioxygen, bis(trimethylsilyl)selenide ((TMS)₂Se), trialkyl phosphine selenides such as (tri-noctylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl)telluride ((TMS)₂Te), bis(trimethylsilyl)sulfide ((TMS)₂S), a trialkyl phosphine sulfide such as (tri-noctylphosphine) sulfide (TOPS), an ammonium salt such as an ammonium halide (e.g., NH₄Cl), tris(trimethylsilyl)phosphide ((TMS)₃P), tris(trimethylsilyl)arsenide ((TMS)₃As), or tris(trimethylsilyl)antimonide ((TMS)₃Sb). In certain embodiments, the M donor and the X donor can be moieties within the same molecule.

A coordinating solvent can help control the growth of the quantum dot. A coordinating solvent is a compound having a donor lone pair that, for example, a lone electron pair available to coordinate to a surface of the growing quantum dot (including, e.g., a semiconductor nanocrystal). Solvent coordination can stabilize the growing quantum dot. Examples of coordinating solvents include alkyl phosphines, alkyl phosphine oxides, alkyl phosphonic acids, or alkyl phosphinic acids, however, other coordinating solvents, such as pyridines, furans, and amines may also be suitable for the quantum dot (e.g., semiconductor nanocrystal) production. Additional examples of suitable coordinating solvents include pyridine, tri-n-octyl phosphine (TOP), tri-n-octyl phosphine oxide (TOPO) and trishydroxylpropylphosphine (tHPP), tributylphosphine, tri(dodecyl)phosphine, dibutyl-phosphite, tributyl phosphite, trioctadecyl phosphite, trilauryl phosphite, tris(tridecyl)phosphite, triisodecyl phosphite, bis(2-ethylhexyl)phosphate, tris(tridecyl)phosphate, hexadecylamine, oleylamine, octadecylamine, bis(2-ethylhexyl)amine, octylamine, dioctylamine, trioctylamine, dodecylamine/laurylamine, didodecylamine tridodecylamine, hexadecylamine, dioctadecylamine, trioctadecylamine, phenylphosphonic acid, hexylphosphonic acid, tetradecylphosphonic acid, octylphosphonic acid, octadecylphosphonic acid, propylenediphosphonic acid, phenylphosphonic acid, aminohexylphosphonic acid, dioctyl ether, diphenyl ether, methyl myristate, octyl octanoate, and hexyl octanoate. In certain embodiments, technical grade TOPO can be used.

In certain embodiments, quantum dots can alternatively be prepared with use of non-coordinating solvent(s).

Size distribution during the growth stage of the reaction can be estimated by monitoring the absorption or emission line widths of the particles. Modification of the reaction temperature in response to changes in the absorption spectrum of the particles allows the maintenance of a sharp particle size distribution during growth. Reactants can be added to the nucleation solution during crystal growth to grow larger crystals. For example, for CdSe and CdTe, by stopping growth at a particular semiconductor nanocrystal average diameter and choosing the proper composition of the semiconducting material, the emission spectra of the semiconductor nanocrystals can be tuned continuously over the wavelength range of 300 nm to 5 microns, or from 400 nm to 800 nm.

The particle size distribution of the quantum dots (including, e.g., semiconductor nanocrystals) can be further refined by size selective precipitation with a poor solvent for the quantum dots, such as methanol/butanol. For example, quantum dots can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected quantum dot (e.g., semiconductor nanocrystal) population preferably has no more than a 15% rms deviation from mean diameter, more preferably 10% rms deviation or less, and most preferably 5% rms deviation or less.

Semiconductor nanocrystals and other types of quantum dots preferably have ligands attached thereto. According to one aspect, quantum dots within the scope of the present invention include green CdSe quantum dots having oleic acid ligands and red CdSe quantum dots having oleic acid ligands. Alternatively, or in addition, octadecylphosphonic acid (“ODPA”) ligands may be used instead of oleic acid ligands. The ligands promote solubility of the quantum dots in the polymerizable composition which allows higher loadings without agglomeration which can lead to red shifting.

Ligands can be derived from a coordinating solvent that may be included in the reaction mixture during the growth process.

Ligands can be added to the reaction mixture.

Ligands can be derived from a reagent or precursor included in the reaction mixture for synthesizing the quantum dots.

In certain embodiments, quantum dots can include more than one type of ligand attached to an outer surface.

A quantum dot surface that includes ligands derived from the growth process or otherwise can be modified by repeated exposure to an excess of a competing ligand group (including, e.g., but not limited to, coordinating group) to form an overlayer. For example, a dispersion of the capped quantum dots can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the nanoparticle, including, for example, but not limited to, phosphines, thiols, amines and phosphates.

For example, a quantum dot can be exposed to short chain polymers which exhibit an affinity for the surface and which terminate in a moiety having an affinity for a suspension or dispersion medium. Such affinity improves the stability of the suspension and discourages flocculation of the quantum dot.

Examples of additional ligands include fatty acid ligands, long chain fatty acid ligands, alkyl phosphines, alkyl phosphine oxides, alkyl phosphonic acids, or alkyl phosphinic acids, pyridines, furans, and amines. More specific examples include, but are not limited to, pyridine, tri-n-octyl phosphine (TOP), tri-n-octyl phosphine oxide (TOPO), tris-hydroxylpropylphosphine (tHPP) and octadecylphosphonic acid (“ODPA”). Technical grade TOPO can be used.

Suitable coordinating ligands can be purchased commercially or prepared by ordinary synthetic organic techniques, for example, as described in J. March, Advanced Organic Chemistry, which is incorporated herein by reference in its entirety.

The emission from a quantum dot capable of emitting light can be a narrow Gaussian emission band that can be tuned through the complete wavelength range of the ultraviolet, visible, or infra-red regions of the spectrum by varying the size of the quantum dot, the composition of the quantum dot, or both. For example, a semiconductor nanocrystal comprising CdSe can be tuned in the visible region; a semiconductor nanocrystal comprising InAs can be tuned in the infra-red region. The narrow size distribution of a population of quantum dots capable of emitting light can result in emission of light in a narrow spectral range. The population can be monodisperse preferably exhibits less than a 15% rms (root-mean-square) deviation in diameter of such quantum dots, more preferably less than 10%, most preferably less than 5%. Spectral emissions in a narrow range of no greater than about 75 nm, preferably no greater than about 60 nm, more preferably no greater than about 40 nm, and most preferably no greater than about 30 nm full width at half max (FWHM) for such quantum dots that emit in the visible can be observed. IR-emitting quantum dots can have a FWHM of no greater than 150 nm, or no greater than 100 nm. Expressed in terms of the energy of the emission, the emission can have a FWHM of no greater than 0.05 eV, or no greater than 0.03 eV. The breadth of the emission decreases as the dispersity of the light-emitting quantum dot diameters decreases.

Quantum dots can have emission quantum efficiencies such as greater than 10%, 20%, 30%, 40%, 50%, 60%, 70%, 80%, or 90%.

The narrow FWHM of quantum dots can result in saturated color emission. The broadly tunable, saturated color emission over the entire visible spectrum of a single material system is unmatched by any class of organic chromophores (see, for example, Dabbousi et al., J. Phys. Chem. 101, 9463 (1997), which is incorporated by reference in its entirety). A monodisperse population of quantum dots will emit light spanning a narrow range of wavelengths.

Useful quantum dots according to the present invention are those that emit wavelengths characteristic of red light. In certain preferred embodiments, quantum dots capable of emitting red light emit light having a peak center wavelength in a range from about 615 nm to about 635 nm, and any wavelength or range in between whether overlapping or not. For example, the quantum dots can be capable or emitting red light having a peak center wavelength of about 635 nm, about 630 nm, of about 625 nm, of about 620 nm, of about 615 nm.

Useful quantum dots according to the present invention are also those that emit wavelength characteristic of green light. In certain preferred embodiments, quantum dots capable of emitting green light emit light having a peak center wavelength in a range from about 520 nm to about 545 nm, and any wavelength or range in between whether overlapping or not. For example, the quantum dots can be capable or emitting green light having a peak center wavelength of about 520 nm, of about 525 nm, of about 535 nm, of about 540 nm or of about 540 nm.

According to further aspects of the present invention, the quantum dots exhibit a narrow emission profile in the range of between about 23 nm and about 60 nm at full width half maximum (FWHM). The narrow emission profile of quantum dots of the present invention allows the tuning of the quantum dots and mixtures of quantum dots to emit saturated colors thereby increasing color gamut and power efficiency beyond that of conventional LED lighting displays. According to one aspect, green quantum dots designed to emit a predominant wavelength of, for example, about 523 nm and having an emission profile with a FWHM of about, for example, 37 nm are combined, mixed or otherwise used in combination with red quantum dots designed to emit a predominant wavelength of about, for example, 617 nm and having an emission profile with a FWHM of about, for example 32 nm. Such combinations can be stimulated by blue light to create trichromatic white light.

Quantum dots in accordance with the present invention can be included in various formulations depending upon the desired utility. According to one aspect, quantum dots are included in flowable formulations or liquids to be included, for example, into clear vessels, such as the stress-resistant tubes described herein, which are to be exposed to light. Such formulations can include various amounts of one or more type of quantum dots and one or more host materials. Such formulations can further include one or more scatterers. Other optional additives or ingredients can also be included in a formulation. In certain embodiments, a formulation can further include one or more photo initiators. One of skill in the art will readily recognize from the present invention that additional ingredients can be included depending upon the particular intended application for the quantum dots.

An optical material or formulation within the scope of the invention may include a host material, such as can be included in an optical component described herein, which may be present in an amount from about 50 weight percent and about 99.5 weight percent, and any weight percent in between whether overlapping or not. In certain embodiment, a host material may be present in an amount from about 80 to about 99.5 weight percent. Examples of specific useful host materials include, but are not limited to, polymers, oligomers, monomers, resins, binders, glasses, metal oxides, and other nonpolymeric materials. Preferred host materials include polymeric and non-polymeric materials that are at least partially transparent, and preferably fully transparent, to preselected wavelengths of light. In certain embodiments, the preselected wavelengths can include wavelengths of light in the visible (e.g., 400-700 nm) region of the electromagnetic spectrum. Preferred host materials include cross-linked polymers and solvent-cast polymers. Examples of other preferred host materials include, but are not limited to, glass or a transparent resin. In particular, a resin such as a non-curable resin, heat-curable resin, or photocurable resin is suitably used from the viewpoint of processability. Specific examples of such a resin, in the form of either an oligomer or a polymer, include, but are not limited to, a melamine resin, a phenol resin, an alkyl resin, an epoxy resin, a polyurethane resin, a maleic resin, a polyamide resin, polymethyl methacrylate, polyacrylate, polycarbonate, polyvinyl alcohol, polyvinylpyrrolidone, hydroxyethylcellulose, carboxymethylcellulose, copolymers containing monomers or oligomers forming these resins, and the like. Other suitable host materials can be identified by persons of ordinary skill in the relevant art.

Host materials can also comprise silicone materials. Suitable host materials comprising silicone materials can be identified by persons of ordinary skill in the relevant art.

In certain embodiments and aspects of the inventions contemplated by this invention, a host material comprises a photocurable resin. A photocurable resin may be a preferred host material in certain embodiments, e.g., in embodiments in which the composition is to be patterned. As a photo-curable resin, a photo-polymerizable resin such as an acrylic acid or methacrylic acid based resin containing a reactive vinyl group, a photo-crosslinkable resin which generally contains a photo-sensitizer, such as polyvinyl cinnamate, benzophenone, or the like may be used. A heat-curable resin may be used when the photo-sensitizer is not used. These resins may be used individually or in combination of two or more.

In certain embodiments, a host material can comprise a solvent-cast resin. A polymer such as a polyurethane resin, a maleic resin, a polyamide resin, polymethyl methacrylate, polyacrylate, polycarbonate, polyvinyl alcohol, polyvinylpyrrolidone, hydroxyethylcellulose, carboxymethylcellulose, copolymers containing monomers or oligomers forming these resins, and the like can be dissolved in solvents known to those skilled in the art. Upon evaporation of the solvent, the resin forms a solid host material for the semiconductor nanoparticles.

In certain embodiments, acrylate monomers and/or acrylate oligomers which are commercially available from Radcure and Sartomer can be preferred.

Quantum dots can be encapsulated. Nonlimiting examples of encapsulation materials, related methods, and other information that may be useful are described in International Application No. PCT/US2009/01372 of Linton, filed 4 Mar. 2009 entitled “Particles Including Nanoparticles, Uses Thereof, And Methods” and U.S. Patent Application No. 61/240,932 of Nick et al., filed 9 Sep. 2009 entitled “Particles Including Nanoparticles, Uses Thereof, And Methods”, each of the foregoing being hereby incorporated herein by reference in its entirety.

The total amount of quantum dots included in an optical material, such as a host material for example a polymer matrix, within the scope of the invention is preferably in a range from about 0.05 weight percent to about 5 weight percent, and more preferably in a range from about 0.1 weight percent to about 5 weight percent and any value or range in between whether overlapping or not. The amount of quantum dots included in an optical material can vary within such range depending upon the application and the form in which the quantum dots are included (e.g., film, optics (e.g., capillary), encapsulated film, etc.), which can be chosen based on the particular end application. For instance, when an optic material is used in a thicker capillary with a longer pathlength (e.g., such as in BLUs for large screen television applications), the concentration of quantum dots can be closer to 0.5%. When an optical material is used in a thinner capillary with a shorter pathlength (e.g., such as in BLUs for mobile or hand-held applications), the concentration of quantum dots can be closer to 5%.

A film comprising an optical material prepared from quantum dot formulations describe herein can be prepared by coating the quantum dot formulation onto a surface, and then UV curing. Example of methods for preparing films include, but are not limited to, a variety of film casting, spin casting and coating techniques, which are well known. Examples of several coating techniques that can be utilized include, but are not limited to, screen printing, gravure, slot, curtain and bead coating.

The ratio of quantum dots used in an optical material is determined by the emission peaks of the quantum dots used. For example, when quantum dots capable of emitting green light having a peak center wavelength in a range from about 514 nm to about 545 nm, and any wavelength in between whether overlapping or not, and quantum dots capable of emitting red light having a peak center wavelength in a range from about 615 nm to about 640 nm, and any wavelength in between whether overlapping or not, are used in an optical material, the ratio of the weight percent green-emitting quantum dots to the weight percent of red-emitting quantum dots can be in a range from about 12:1 to about 1:1, and any ratio in between whether overlapping or not.

The above ratio of weight percent green-emitting quantum dots to weight percent red-emitting quantum dots in an optical material can alternatively be presented as a molar ratio. For example, the above weight percent ratio of green to red quantum dots range can correspond to a green to red quantum dot molar ratio in a range from about 24.75 to 1 to about 5.5 to 1, and any ratio in between whether overlapping or not.

The ratio of the blue to green to red light output intensity in white trichromatic light emitted by a quantum dot containing BLU described herein including blue-emitting solid state inorganic semiconductor light emitting devices (having blue light with a peak center wavelength in a range from about 450 nm to about 460 nm, and any wavelength in between whether overlapping or not), and an optical material including mixtures of green-emitting quantum dots and red-emitting quantum dots within the above range of weight percent ratios can vary within the range. For example, the ratio of blue to green light output intensity therefor can be in a range from about 0.75 to about 4 and the ratio of green to red light output intensity therefor can be in a range from about 0.75 to about 2.0. In certain embodiments, for example, the ratio of blue to green light output intensity can be in a range from about 1.0 to about 2.5 and the ratio of green to red light output intensity can be in a range from about 0.9 to about 1.3.

Scatterers, also referred to as scattering agents, within the scope of the invention may be present, for example, in an amount of between about 0.01 weight percent and about 1 weight percent. Amounts of scatterers outside such range may also be useful. Examples of light scatterers (also referred to herein as scatterers or light scattering particles) that can be used in the embodiments and aspects of the inventions described herein, include, without limitation, metal or metal oxide particles, air bubbles, and glass and polymeric beads (solid or hollow). Other light scatterers can be readily identified by those of ordinary skill in the art. In certain embodiments, scatterers have a spherical shape. Preferred examples of scattering particles include, but are not limited to, TiO₂, SiO₂, BaTiO₃, BaSO₄, and ZnO. Particles of other materials that are non-reactive with the host material and that can increase the absorption pathlength of the excitation light in the host material can be used. In certain embodiments, light scatterers may have a high index of refraction (e.g., TiO₂, BaSO₄, etc) or a low index of refraction (gas bubbles).

Selection of the size and size distribution of the scatterers is readily determinable by those of ordinary skill in the art. The size and size distribution can be based upon the refractive index mismatch of the scattering particle and the host material in which the light scatterers are to be dispersed, and the preselected wavelength(s) to be scattered according to Rayleigh scattering theory. The surface of the scattering particle may further be treated to improve dispersability and stability in the host material. In one embodiment, the scattering particle comprises TiO₂ (R902+ from DuPont) of 0.2 μm particle size, in a concentration in a range from about 0.01 to about 1% by weight.

The amount of scatterers in a formulation is useful in applications where the ink is contained in a clear vessel having edges to limit losses due the total internal reflection. The amount of the scatterers may be altered relative to the amount of quantum dots used in the formulation. For example, when the amount of the scatter is increased, the amount of quantum dots may be decreased.

Examples of thixotropes which may be included in a quantum dot formulation, also referred to as rheology modifiers, include, but are not limited to, fumed metal oxides (e.g., fumed silica which can be surface treated or untreated (such as Cab-O-Sil™ fumed silica products available from Cabot Corporation), fumed metal oxide gels (e.g., a silica gel). An optical material can include an amount of thixotrope in a range from about 0.5 to about 12 weight percent or from about 5 to about 12 weight percent. Other amounts outside the range may also be determined to be useful or desirable.

In certain embodiments, a formulation including quantum dots and a host material can be formed from an ink comprising quantum dots and a liquid vehicle, wherein the liquid vehicle comprises a composition including one or more functional groups that are capable of being cross-linked. The functional units can be cross-linked, for example, by UV treatment, thermal treatment, or another cross-linking technique readily ascertainable by a person of ordinary skill in a relevant art. In certain embodiments, the composition including one or more functional groups that are capable of being cross-linked can be the liquid vehicle itself. In certain embodiments, it can be a co-solvent. In certain embodiments, it can be a component of a mixture with the liquid vehicle.

One particular example of a preferred method of making an ink is as follows. A solution including quantum dots having the desired emission characteristics well dispersed in an organic solvent is combined with the desired resin monomer under nitrogen conditions, until the desired monomer to quantum dot ratio is achieved. This mixture is then vortex mixed under oxygen free conditions until the quantum dots are well dispersed. The final components of the resin are then added to the quantum dot dispersion, and are then sonicated mixed to ensure a fine dispersion. Solvent may then be removed.

A tube or capillary comprising an optical material prepared from such finished ink can be prepared by then introducing the ink into the tube via a wide variety of methods, and then UV cured under intense illumination for some number of seconds for a complete cure. According to one aspect, the ink is introduced into the tube under oxygen-free and water free conditions.

A tube or capillary comprising an optical material prepared from such finished ink can be prepared by then introducing the ink into the tube via a wide variety of methods, sealing the tube under oxygen free conditions and then UV curing under intense illumination for some number of seconds for a complete cure. According to one aspect, the ink is introduced into the tube under oxygen-free and, optionally, water free conditions.

In certain aspects and embodiments of the inventions taught herein, the optic including the cured quantum dot containing ink is exposed to light flux for a period of time sufficient to increase the photoluminescent efficiency of the optical material.

In certain embodiments, the optical material is exposed to light and heat for a period of time sufficient to increase the photoluminescent efficiency of the optical material.

In preferred certain embodiments, the exposure to light or light and heat is continued for a period of time until the photoluminescent efficiency reaches a substantially constant value.

In one embodiment, for example, after the optic, i.e. tube or capillary, is filled with quantum dot containing ink under oxygen free and water free conditions, cured, and sealed (regardless of the order in which the curing and sealing steps are conducted) to produce an optic having substantially no oxygen and substantially no water within the sealed optic, the optic is exposed to 25-35 mW/cm² light flux with a wavelength in a range from about 365 nm to about 470 nm while at a temperature of in a range from about 25 to 80° C., for a period of time sufficient to increase the photoluminescent efficiency of the ink. In one embodiment, for example, the light has a wavelength of about 450 nm, the light flux is 30 mW/cm², the temperature is 80° C., and the exposure time is 3 hours.

Additional information that may be useful in connection with the present disclosure and the inventions described herein is included in International Application No. PCT/US2009/002796 of Coe-Sullivan et al, filed 6 May 2009, entitled “Optical Components, Systems Including An Optical Component, And Devices”; International Application No. PCT/US2009/002789 of Coe-Sullivan et al, filed 6 May 2009, entitled: “Solid State Lighting Devices Including Quantum Confined Semiconductor Nanoparticles, An Optical Component For A Solid State Light Device, And Methods”; International Application No. PCT/US2010/32859 of Modi et al, filed 28 Apr. 2010 entitled “Optical Materials, Optical Components, And Methods”; International Application No. PCT/US2010/032799 of Modi et al, filed 28 Apr. 2010 entitled “Optical Materials, Optical Components, Devices, And Methods”; International Application No. PCT/US2011/047284 of Sadasivan et al, filed 10 Aug. 2011 entitled “Quantum Dot Based Lighting”; International Application No. PCT/US2008/007901 of Linton et al, filed 25 Jun. 2008 entitled “Compositions And Methods Including Depositing Nanomaterial”; U.S. patent application Ser. No. 12/283,609 of Coe-Sullivan et al, filed 12 Sep. 2008 entitled “Compositions, Optical Component, System Including An Optical Component, Devices, And Other Products”; International Application No. PCT/US2008/10651 of Breen et al, filed 12 Sep. 2008 entitled “Functionalized Nanoparticles And Method”; U.S. Pat. No. 6,600,175 of Baretz, et al., issued Jul. 29, 2003, entitled “Solid State White Light Emitter And Display Using Same”; and U.S. Pat. No. 6,608,332 of Shimizu, et al., issued Aug. 19, 2003, entitled “Light Emitting Device and Display”; each of the foregoing being hereby incorporated herein by reference in its entirety.

LEDs within the scope of the present invention include any conventional LED such as those commercially available from Citizen, Nichia, Osram, Cree, or Lumileds. Useful light emitted from LEDs includes white light, off white light, blue light, green light and any other light emitted from an LED.

### Example I

### Preparation of Semiconductor Nanocrystals Capable of Emitting Red Light

### Synthesis of CdSe Cores

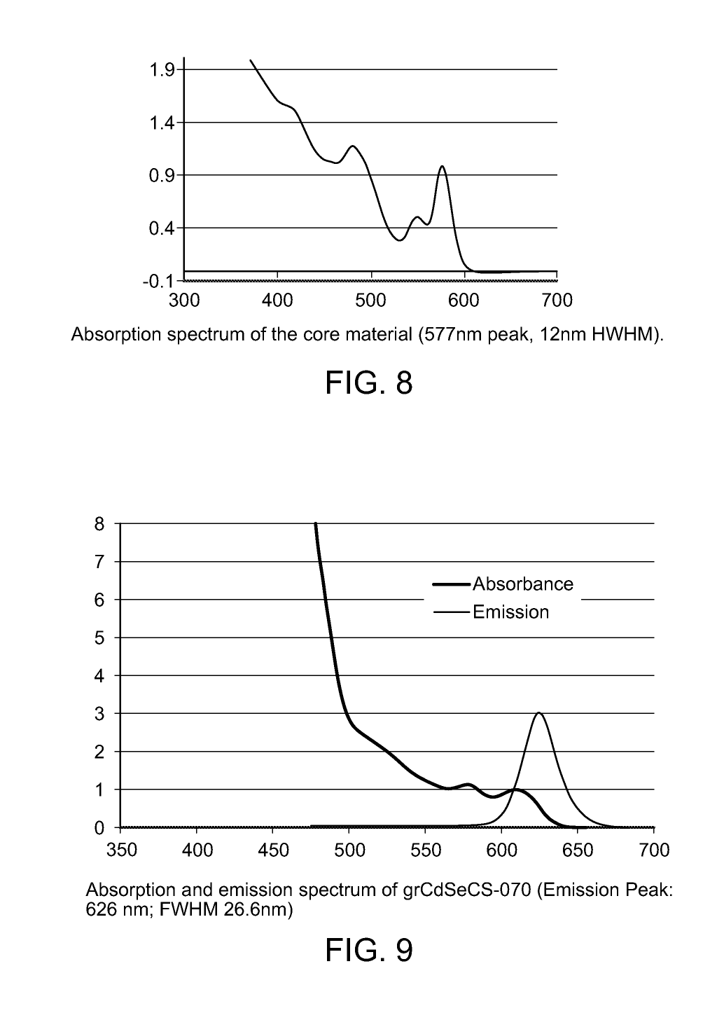

The following were added to a 1 L glass reaction vessel: trioctylphosphine oxide (15.42 g), 1-octadecene (225.84 g), 1-octadecylphosphonic acid (1.88 g, 5.63 mmol). The vessel was subjected to 3 cycles of vacuum/nitrogen at 120° C., and the temperature was raised to 270° C. under nitrogen. At 270° C., a solution of 0.25M diisobutylphosphine selenide in N-dodecylpyrrolidone (DIBP-Se, 17.56 mL, 4.39 mmol) and Cd(Oleate)₂ (1M solution in trioctylphosphine, 22.51 mL, 5.63 mmol) was rapidly injected, within a period of less than 1 second, followed by injection of 1-octadecene (121.0 mL) to rapidly drop the temperature to about 240° C., resulting in the production of quantum dots with an initial absorbance peak between 420-450 nm. 5-20 seconds after the ODE quench, a solution of Cd(Oleate)₂ (0.5M in a 50/50 v/v mixture of TOP and ODE) was continuously introduced along with a solution of DIBP-Se (0.4M in a 60/40 v/v mixture of N-dodecylpyrrolidone and ODE) at a rate of 55.7 mL/hr. At 15 min, the infusion rate was increased to 111.4 mL/hr. At 25 min, the infusion rate was increased to 167.1 mL/hour. At 35 min, the infusion rate was increased to 222.8 mL/hr. At 45 min, the infusion rate was increased to 297.0 mL/hr. At 55 min, the infusion rate was increased to 396 mL/hr. A total of 143.4 mL of each precursor was delivered while the temperature of the reactor was maintained between 215-240° C. At the end of the infusion, the reaction vessel was cooled using room temperature airflow over a period of 5-15 min. The final material was used as is without further purification (First absorbance peak: 576 nm, total volume: 736.5 mL, Reaction yield: 99%). FIG. 8 depicts the absorption spectrum of the core material (577 nm peak, 12 nm HWHM).

Synthesis of CdSe/ZnS/CdZnS Core/Shell/Shell (grCdSeCS-058):

The CdSe core synthesized from above, with a first absorbance peak of 577 nm (85.55 mL, 8 mmol Cd), is mixed with Zn(Oleate)₂ (24.89 mL, 0.5M in TOP) and 1-octadecene (71.52 mL). The solution is heated to 320° C., upon which a syringe containing 1-dodecanethiol (22.36 mL) is swiftly injected. After 2 min, when the temperature recovers to 310-315° C., the overcoat precursors are delivered via a syringe pump over a period of 30 min. The two overcoating precursor stocks consist of the following: 1) Zn(Oleate)₂ (23.85 mL, 0.5M in TOP) mixed with Cd(Oleate)₂ (67.56 mL, 1.0M in TOP), and 2) dodecanethiol (28.63 mL) mixed with 1-octadecene (50.23 mL) and TOP (12.56 mL). During the overcoating precursor infusion, the temperature is kept between 320-330° C. Any volatiles from the system are allowed to distill over and leave the system in order for the temperature to reach 320-330° C. After the infusion ended, the sample was annealed for 5 min at 320-330° C. and cooled to room temperature over a period of 5-15 min. The final core/shell material was precipitated via the addition of butanol and methanol at a 2:1 ratio v/v. The pellet was isolated via centrifugation, and redispersed into toluene (200 mL) for storage (Emission 626 nm, FWHM 26.6 nm, Film EQE at RT: 99%, Film EQE at 140° C.: 65%). FIG. 9 is an absorption and emission spectrum of grCdSeCS-070 (Emission Peak: 626 nm; FWHM 26.6 nm).

### Example II

### Preparation of Semiconductor Nanocrystals Capable of Emitting Green Light

### Synthesis of CdSe Cores (448 nm Target)

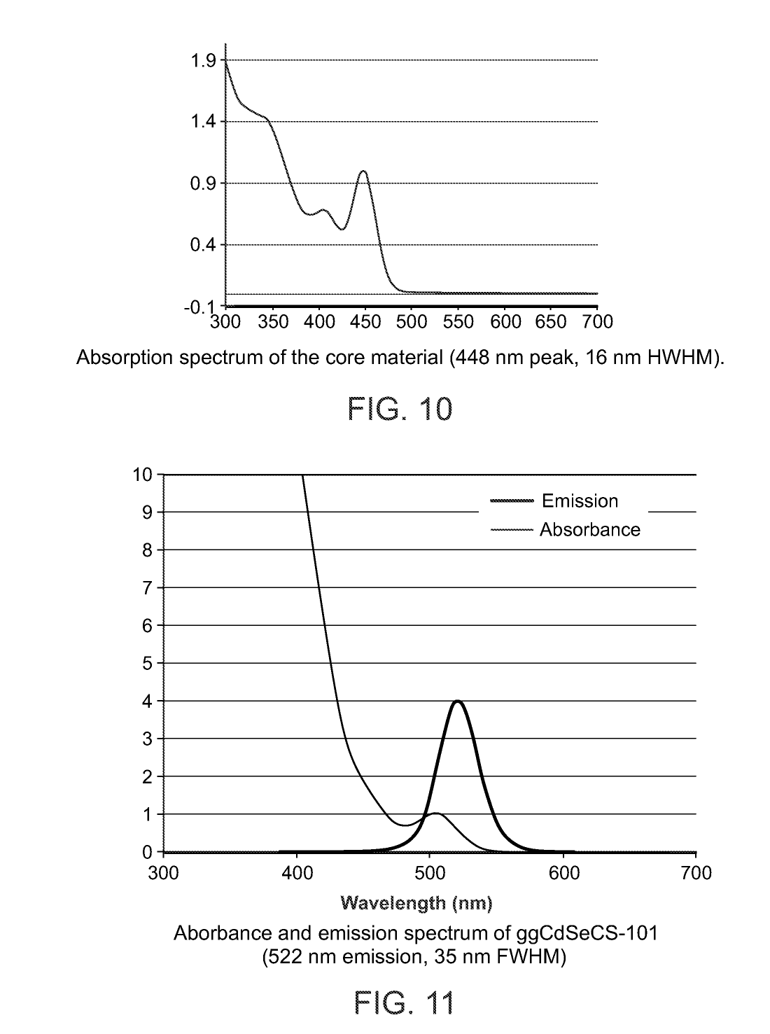

The following were added to a 1 L steel reaction vessel: trioctylphosphine oxide (51.88 g), 1-octadecene (168.46 g), 1-octadecylphosphonic acid (33.09 g, 98.92 mmol), and Cd(Oleate)₂ (1M solution in trioctylphosphine, 98.92 mL, 98.92 mmol). The vessel was subjected to 3 cycles of vacuum/nitrogen at 120° C., and the temperature was raised to 270° C. under nitrogen. At 270° C., a solution of 1M diisobutylphosphine selenide in N-dodecylpyrrolidone (DIBP-Se, 77.16 mL, 77.16 mmol) was rapidly injected, within a period of less than 1 second, followed by injection of 1-octadecene (63.5 mL) to rapidly drop the temperature to about 240° C. resulting in the production of quantum dots with an initial absorbance peak between 420-430 nm. 5-20 seconds after the ODE injection, a solution of Cd(oleate)₂ (0.5M in a 50/50 v/v mixture of TOP and ODE) was continuously introduced along with a solution of DIBP-Se (0.4M in a 60/40 v/v mixture of N-dodecylpyrrolidone and ODE) at a rate of 29.0 mL/min. A total of 74.25 mL of each precursor was delivered while the temperature of the reactor was maintained between 205-240° C. At the end of the infusion, the reaction vessel was cooled rapidly by immersing the reactor in a squalane bath chilled with liquid nitrogen to rapidly bring the temperature down to <150° C. (within 2 minutes). The final material was used as is without further purification (First absorbance peak: 448 nm, Total volume: 702 mL, Reaction yield: 99%). FIG. 10 is an absorption spectrum of the core material (448 nm peak, 16 nm HWHM).

Synthesis of CdSe/ZnS/CdZnS Core/Shell/Shell (ggCdSeCS-101):

The CdSe core synthesized from above, with a first absorbance peak of 448 nm (318.46 mL, 55.22 mmol Cd), is mixed with dodecanethiol (236.30 mL) in a syringe. All Zn(Oleate) precursors (0.5M in trioctylphosphine) have been doped with 0.85% acetic acid by weight. A reaction flask containing Zn(Oleate)₂ (986.60 mL, 0.5M in TOP) is heated to 300° C., upon which the syringe containing cores and 1-dodecanethiol is swiftly injected. When the temperature recovers to 310° C. (between 2-8 min), the overcoat precursors are delivered via a syringe pump over a period of 32 min. The two overcoating precursor stocks consist of the following: 1) Zn(Oleate)₂ (1588.80 mL, 0.5M in TOP) mixed with Cd(Oleate)₂ (539.60 mL, 1.0M in TOP), and 2) dodecanethiol (221.99 mL). During the overcoating precursor infusion, the temperature was kept between 320-330° C. Any volatiles from the system were allowed to distill over and leave the system in order for the temperature to reach 320-330° C. After the infusion ended, the sample was annealed for 3 min at 320-330° C. and cooled to room temperature over a period of 5-15 min. The final core/shell material was precipitated via the addition of butanol and methanol at a 2:1 ratio v/v. The pellet was isolated via centrifugation, and redispersed into toluene for storage (Emission 522 nm+/−2 nm, FWHM 36 nm, Film EQE at RT: 99%, Film EQE at 140 C: >90%). FIG. 11 is an absorbance and emission spectrum of ggCdSeCS-101 (522 nm emission, 35 nm FWHM).

### Example III

### Preparation of Semiconductor Nanocrystals Capable of Emitting Green Light

### Synthesis of CdSe Cores (448 nm Target)

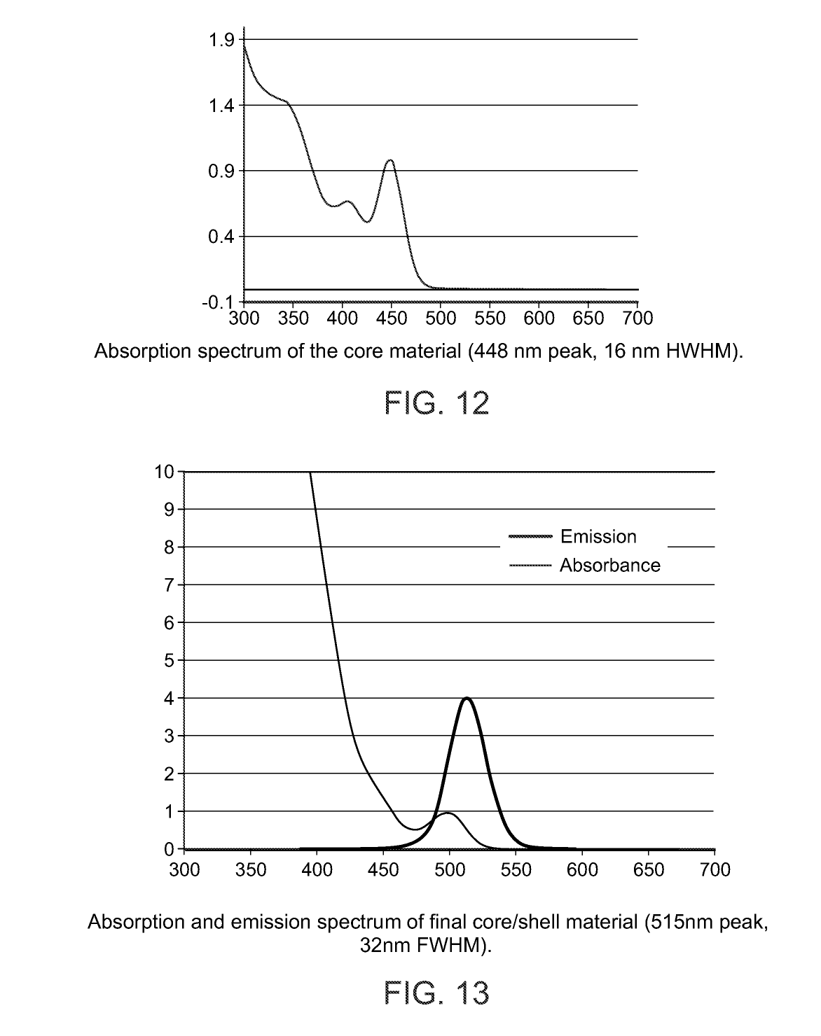

The following were added to a 1 L steel reaction vessel: trioctylphosphine oxide (51.88 g), 1-octadecene (168.46 g), 1-octadecylphosphonic acid (33.09 g, 98.92 mmol), and Cd(Oleate)₂ (1M solution in trioctylphosphine, 98.92 mL, 98.92 mmol). The vessel was subjected to 3 cycles of vacuum/nitrogen at 120° C., and the temperature was raised to 270° C. under nitrogen. At 270° C., a solution of 1M diisobutylphosphine selenide in N-dodecylpyrrolidone (DIBP-Se, 77.16 mL, 77.16 mmol) was rapidly injected, within a period of less than 1 second, followed by injection of 1-octadecene (63.5 mL) to rapidly drop the temperature to about 240° C. resulting in the production of quantum dots with an initial absorbance peak between 420-430 nm. 5-20 seconds after the ODE injection, a solution of Cd(oleate)₂ (0.5M in a 50/50 v/v mixture of TOP and ODE) was continuously introduced along with a solution of DIBP-Se (0.4M in a 60/40 v/v mixture of N-dodecylpyrrolidone and ODE) at a rate of 29.0 mL/min. A total of 74.25 mL of each precursor was delivered while the temperature of the reactor was maintained between 205-240° C. At the end of the infusion, the reaction vessel was cooled rapidly by immersing the reactor in a squalane bath chilled with liquid nitrogen to rapidly bring the temperature down to <150° C. (within 2 minutes). The final material was used as is without further purification (First absorbance peak: 448 nm, Total volume: 702 mL, Reaction yield: 99%). FIG. 12 is an absorption spectrum of the core material (448 nm peak, 16 nm HWHM).

Synthesis of CdSe/ZnS/CdZnS Core/Shell/Shell (ggCdSeCS-052)

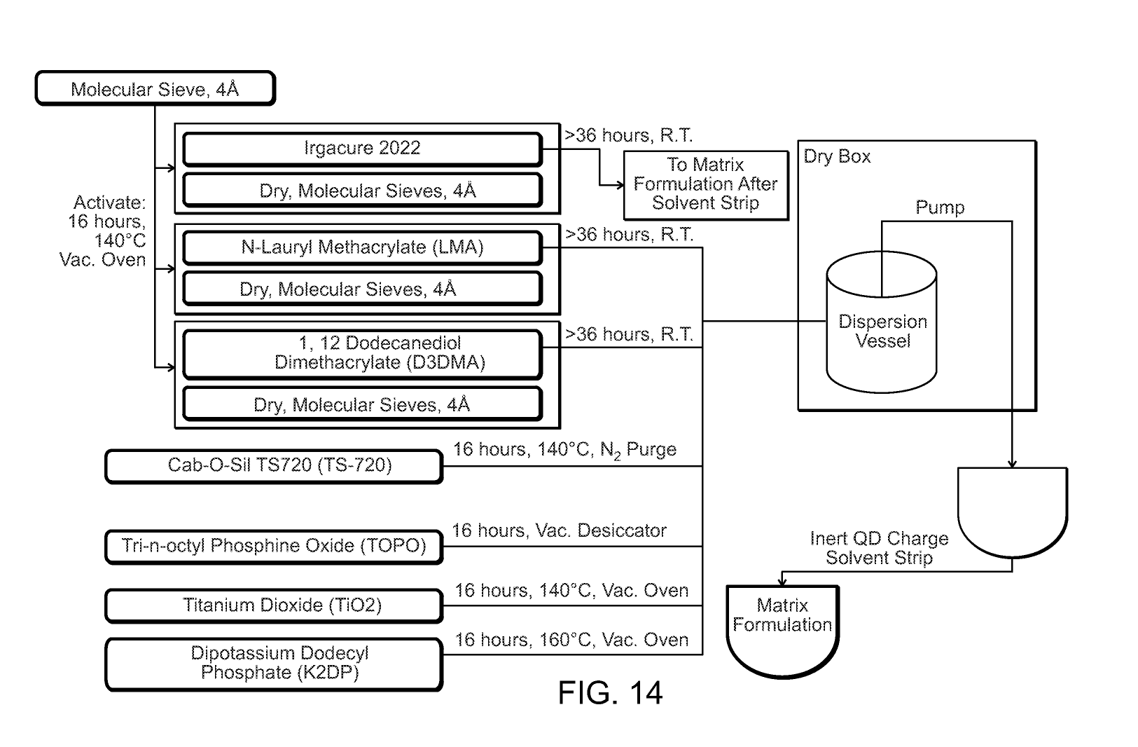

The CdSe core synthesized from above, with a first absorbance peak of 448 nm (43.56 mL, 6.64 mmol Cd), is mixed with dodecanethiol (28.90 mL) in a syringe. A reaction flask containing Zn(Oleate)₂ (120.7 mL, 0.5M in TOP) is heated to 300° C., upon which the syringe containing cores and 1-dodecanethiol is swiftly injected. When the temperature recovers to 310° C. (between 2-8 min), the overcoat precursors are delivered via a syringe pump over a period of 32 min. The two overcoating precursor stocks consist of the following: 1) Zn(Oleate)₂ (195.22 mL, 0.5M in TOP) mixed with Cd(Oleate)₂ (65.07 mL, 1.0M in TOP), and 2) dodecanethiol (42.86 mL) mixed 1-octadecene (7.36 mL) and n-trioctylphosphine (1.84 mL). During the overcoating precursor infusion, the temperature was kept between 320-330° C. Any volatiles from the system were allowed to distill over and leave the system in order for the temperature to reach 320-330° C. After the infusion ended, the sample was annealed for 3 min at 320-330° C. and cooled to room temperature over a period of 5-15 min. The final core/shell material was precipitated via the addition of butanol and methanol at a 2:1 ratio v/v. The pellet was isolated via centrifugation, and redispersed into toluene for storage (Emission 515 nm, FWHM 32 nm, Film EQE at RT: 99%, Film EQE at 140 C: >90%). FIG. 13 is an absorption and emission spectrum of the final core/shell material (515 nm peak, 32 nm FWHM).

### Example IV

### Preparation of Polymerizable Formulation Including Quantum Dots

A polymerizable formulation including quantum dots was prepared as follows:

A clean, dry Schlenk flask equipped with a magnetic stir bar and rubber septum was charged with 57.75 mL lauryl methacrylate (LMA) (Aldrich Chemical, 96%), 9.93 mL ethylene glycol diacrylate (EGDMA) as well as any additive(s) indicated for the particular example. The solution was inserted using a vacuum manifold and degassed in a standard protocol by freeze-pump-thawing the mixture three times successively using liquid nitrogen. The thawed solution is finally placed under nitrogen and labeled “monomer solution”.

Separately, a clean, dry Schlenk flask equipped with a magnetic stir bar and rubber septum was charged with 6.884 g treated fumed silica (TS-720, Cabot Corp), 103.1 mg titanium dioxide (R902+, DuPont Corp.) and inserted under nitrogen. To this is added 69 mL toluene (dry and oxygen free). The mixture is placed in an ultrasonic bath for 10 minutes and then stirred under nitrogen. This is labeled “metal oxide slurry”.

Separately, a clean, dry Schlenk flask equipped with a magnetic stir bar and rubber septum was inserted under nitrogen. The flask was then charged with a green quantum dot solution (13.1 mL) in toluene, red quantum dot solution (2.55 mL) in toluene and 69 mL additional toluene via syringe and allowed to stir for 5 minutes. Over 6 minutes, the contents of the “monomer solution flask” were added via syringe and stirred for an additional five minutes. The contents of the “metal oxide slurry” flask were next added over 5 minutes via cannula and rinsed over with the aid of a minimum amount of additional toluene.

The stirred flask was then placed in a warm water bath (<60° C.), covered with aluminum foil to protect from light and placed under a vacuum to remove all of the toluene to a system pressure of <200 mtorr. After solvent removal was completed, slurry was removed from heat and, with stirring, 640 μL Irgacure 2022 photoinitiator (BASF), without purification, was added via syringe and allowed to stir for 5 minutes. The final ink was then ready for transfer to a fill station.

### Example IV

### Filling Capillary, Forming Quantum Dot Matrix, and Capillary Sealing

According to aspects of the present disclosure, tubes can be filled individually in series one at a time or they can be filled in parallel with many tubes being filled at the same time, such as in a batch method. Methods of filling tubes can use capillary action, pressure differentials, gravity, vacuum or other forces or methods known to those of skill in the art to fill tubes with flowable quantum dot formulations. According to one aspect, a stress-resistant tube was filled under oxygen free and water free conditions with the quantum dot formulation of Example III as follows. Glass capillaries are maintained in a vacuum drying oven under nitrogen for 12 hours at a pressure of less than 1 torr and a temperature of 120° C. A quantum dot ink formulation is maintained in a quantum dot ink vessel under nitrogen. Capillaries with both ends open are removed from the vacuum drying oven and placed into a vacuum fill vessel with an open end down into quantum dot ink. The quantum dot ink vessel is connected to the vacuum fill vessel via tubing and valves such that ink is able to flow from the quantum dot ink vessel to the vacuum fill vessel by applying pressure differentials. The pressure within the vacuum fill vessel is reduced to less than 200 torr and then repressurized with nitrogen. Quantum dot ink is admitted into the vacuum fill vessel by pressurization of the quantum dot ink vessel and the capillaries were allowed to fill under oxygen free conditions. Alternatively, the vacuum fill vessel can be evacuated thereby drawing the fluid up into the capillaries. After the capillaries are filled, the system is bled to atmospheric pressure. The exterior of the capillaries is then cleaned using toluene. The polymerizable formulation within the glass tube is polymerized as follows. The tubes are transferred to a photopolymerization reactor where the tubes are placed on a continuously moving belt and exposed for 30 seconds to light from a mercury “H” or “D” lamp at a fluence of 250-1000 J/cm. After polymerization, the tubes are end sealed, preferably under a nitrogen atmosphere, using an epoxy.

According to an additional embodiment with reference to FIG. 2, a capillary with one end sealed is connected to a filling head. A suitable filling head holds and maintains the capillary in a vacuum tight seal. The capillary is evacuated by vacuum. Quantum dot ink under nitrogen pressure is then filled into the capillary. The quantum dot ink is maintained at a temperature below which thermal-induced polymerization takes place. Alternatively, a pump can be used to pump the quantum dot ink through a filling head and into the capillary. The quantum dot ink can be maintained under vacuum sufficient to degas the quantum dot ink. The ink may be agitated or stirred or recirculated which aids in the degassing process. If a recirculation loop is used, heat may be generated by the pump used to recirculate the quantum dot ink which may increase the temperature of the quantum dot ink. To maintain the temperature of the quantum dot ink at a temperature below which thermal-induced polymerization takes place, a heat exchanger may be used within the recirculating loop to remove heat from the quantum dot ink that may have been added due to the recirculating pump. The lines and filling head is flushed with nitrogen. The capillary is then removed from the filling head under an atmosphere of nitrogen or nitrogen is backfilled into the capillary and the end sealed, such as by melting the capillary end and sealing, to produce an optical component comprising a structural member (e.g., a vessel, a capillary, a tube, etc.) including a quantum dot formulation therein and having no or substantially no oxygen within the sealed optical component. The quantum dot ink in the sealed capillary is then cured within the capillary through exposure to ultra violet light of 395 nm wavelength or equivalent wavelength.

The completed, sealed capillary(ies) were exposed to 30 mW/cm² light flux with a wavelength of about 450 nm, for 12 hours at 60° C. prior to any analytical testing.

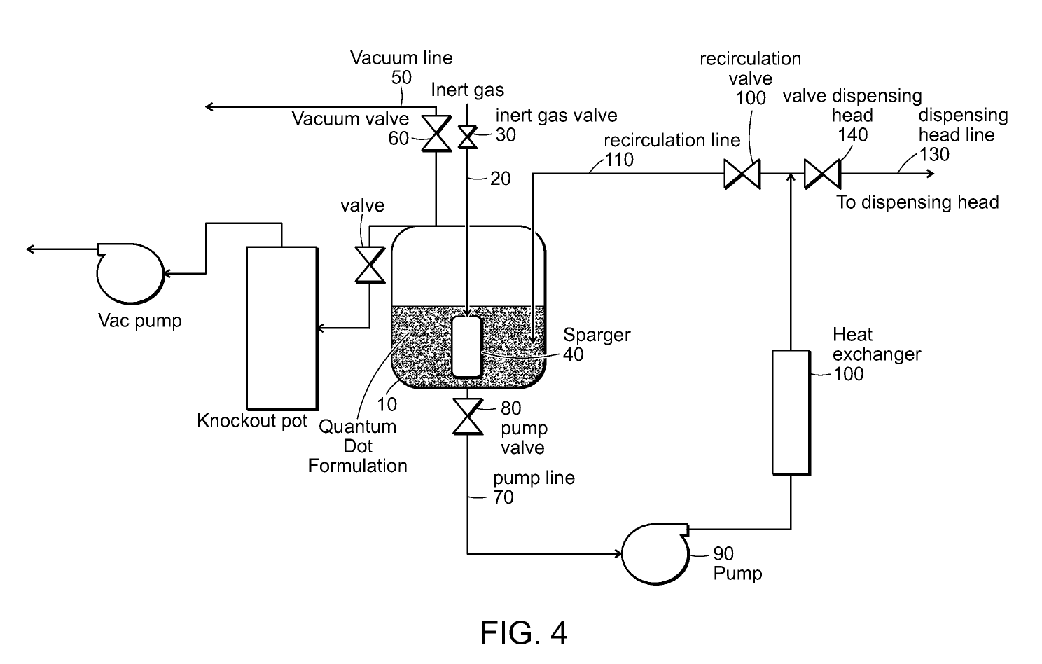

An exemplary system for maintaining and processing a quantum dot formulation is shown in schematic in FIG. 4. A quantum dot formulation is maintained in a closed vessel 10. The vessel includes an inert gas input line 20 for inputting inert gas into the vessel 10 through an inert gas valve 30. The inert gas input line is connected to a sparger 40 disposed within the vessel 10 and is intended to be covered with the quantum dot formulation as shown. Inert gas moves through the inert gas input line 20 into the vessel 10 and into the quantum dot formulation. A vacuum line 50 is connected to the vessel 10 through vacuum valve 60. The vacuum line 50 is connected to a vacuum (not shown). The vacuum draws a vacuum within the closed vessel 10 thereby removing any inert gas and any gases such as oxygen that may be dissolved within the quantum dot formulation. The vessel may also include a stirrer (not shown) which can stir the quantum dot formulation within the vessel. The inert gas valve may be closed thereby subjecting the quantum dot formulation within the vessel 10 to a vacuum which serves to degas the quantum dot formulation. A pump line 70 is connected to the vessel 10 through pump valve 80. A pump 90 is used to pump quantum dot formulation out of the vessel 10. The quantum dot formulation can enter heat exchanger 100 which serves to maintain the quantum dot formulation at a desired temperature. The quantum dot formulation may then enter a recirculation line 110 via a recirculation valve 120. The recirculation line 110 returns the quantum dot formulation to the vessel 10. The quantum dot formulation may enter a dispensing head line 130 via a dispensing head valve 140.

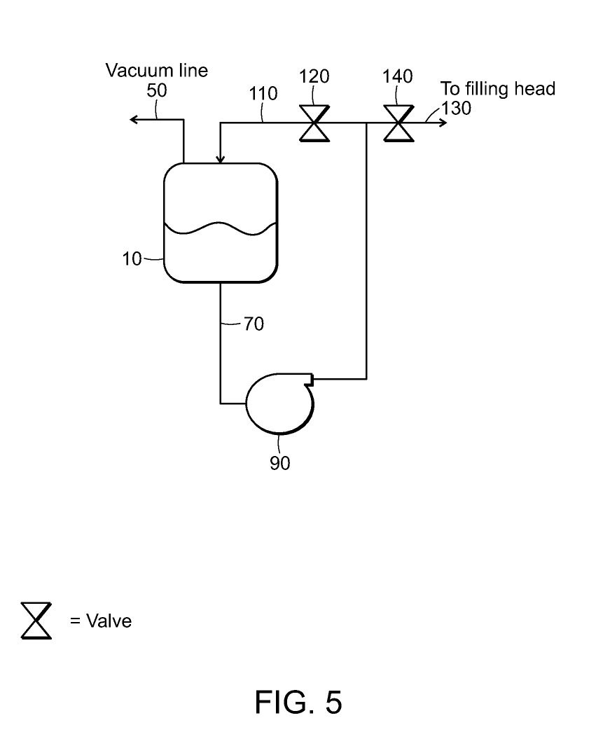

According to an alternative embodiment shown in schematic in FIG. 5, a closed vessel 10 includes a quantum dot formulation. A vacuum line 50 is attached to the vessel 10 through a vacuum valve. A vacuum (not shown) is attached to the vacuum line and draws a vacuum within the closed vessel 10. A pump line 70 is connected to the vessel 10 through pump valve. A pump 90 is used to pump quantum dot formulation out of the vessel 10. The quantum dot formulation may then enter a recirculation line 110 via a recirculation valve 120. The recirculation line 110 returns the quantum dot formulation to the vessel 10. The quantum dot formulation may enter a dispensing head line 130 via a dispensing head valve 140.

According to an alternative embodiment shown in schematic in FIG. 6, a closed vessel 10 includes a quantum dot formulation. A vacuum line 50 is attached to the vessel 10 through a vacuum valve. A vacuum (not shown) is attached to the vacuum line and draws a vacuum within the closed vessel 10. An inert gas input line 20 for inputting inert gas into the vessel 10 is connected to the vessel 10 through an inert gas valve. A stirrer 15 is placed within the vessel 10 for stirring the quantum dot formulation. The quantum dot formulation may enter a dispensing head line 130 via a dispensing head valve 140. According to this embodiment, pressure from the inert gas is used to force quantum dot formulation from the vessel 10 through the dispensing head line and to the dispensing or filling head.

According to an alternative embodiment shown in schematic in FIG. 7, a closed vessel 10 includes a quantum dot formulation. A vacuum line 50 is attached to the vessel 10 through a vacuum valve. A vacuum (not shown) is attached to the vacuum line and draws a vacuum within the closed vessel 10. An inert gas input line 20 for inputting inert gas into the vessel 10 is connected to the vessel 10 through an inert gas valve. A stirrer 15 is disposed within the vessel 10 for stirring the quantum dot formulation. An exit line 150 is connected to the vessel 10 through which the quantum dot formulation may flow. A closed degassing chamber 160 is connected to the exit line 150. The degassing chamber is preferably smaller than the vessel 10 and is designed to degas small volumes of the quantum dot formulation. A vacuum line 50 is attached to the degassing chamber 160 through a vacuum valve. A vacuum (not shown) is attached to the vacuum line and draws a vacuum within the closed degassing chamber 160. The quantum dot formulation within the degassing chamber may enter a dispensing head line 130 via a dispensing head valve.

### Example V

### Method of Making Quantum Dot Formulations

An exemplary method and system of making quantum dot formulations substantially free of oxygen and substantially free of water is shown in schematic in FIG. 14. The ingredients of the quantum dot formulation are shown below.

| Ingredient | Target Amount |
|---|---|
| Green quantum dots | 0.0980 g |
| Red quantum dots | 0.1030 g |
| Titanium Dioxide (Tipure R902+) | 0.1500 g |
| Fumed Silica (Cab-O-Sil TS-720) | 6.0000 g |
| Stabilizer (Tri-octyl Phosphine Oxide) | 5.2443 g |
| Emission Stabilizer (dipotassium dodecyl phosphate) | 0.5244 g |
| Photosensitizer (Irgacure 2022) | 1.0721 g |
| Crosslinker (dodecanediol dimethacrylate) | 14.7588 g |
| Monomer (n-lauryl methacrylate) | 72.0493 g |

As shown in FIG. 14, separate components to be added to quantum dots are processed to remove oxygen and or water.

Molecular sieves, 4 angstroms, are activated by placing in a container in a vacuum oven at 140° C. for 12 hours. The molecular sieves are then removed from the oven and the container is sealed. The container is allowed to cool to room temperature prior to use.

To produce dry n-lauryl methacrylate, a representative polymerizable component, molecular sieves, 4 angstroms, are placed into a container and n-lauryl methacrylate is added to the container. The container is sealed and stored in the dark for 16 hours prior to use.

To produce dry 1,12 dodecanediol dimethacrylate, a representative crosslinking agent, molecular sieves, 4 angstroms, are placed into a container and n-lauryl methacrylate is added to the container. The container is sealed, wrapped in aluminum foil and stored in the dark for 16 hours prior to use.

To produce dry Irgacure 2022, a representative photoinitiator, molecular sieves, 4 angstroms, are placed into a container and Irgacure 2022 is added to the container. The container is sealed and stored in the dark prior to use.

To produce dry titanium dioxide, a representative scattering agent, titanium dioxide is added to a vial. The vial is placed in a vacuum oven at 140° C. at reduced pressure for 16 hours.

To produce dry dipotassium dodecylphosphate, dipotassium dodecylphosphate is added to a vial. The vial is placed in a vacuum oven at 160° C. at reduced pressure for 16 hours.

To produce dry tri-n-octyl phosphine oxide, tri-n-octyl phosphine oxide is added to a vial. The vial is placed in a vacuum desiccator where vacuum is applied for 16 hours.

To produce dry fumed silica (Cab-O-Sil TS-720), a representative rheology modifier, Cab-O-Sil TS-720 is added to a vial. The vial is placed in a vacuum oven at 140° C. at reduced pressure or alternatively a nitrogen purge for 16 hours.

According to FIG. 14, each of the components, except the photoinitiator, are removed from their respective vacuum oven or vacuum desiccator, sealed and placed into a dry box. Appropriate amounts of each component are placed in a jacketed dispersion vessel. For example, n-lauryl methacrylate is added to the vessel. 1,12 dodecanediol dimethacrylate is added to the vessel. The temperature of the jacketed vessel is set to about 20° C. Tri-n-octyl phosphine oxide is added to the vessel and the combination is agitated for about 15 minutes until the tri-n-octyl phosphine oxide has fully solubilized.

Dipotassium dodecylphosphate is added to the vessel. Titanium dioxide is added to the vessel. The temperature of the jacketed vessel is set to about 20° C. Cab-O-Sil TS-720 is added slowly to the jacketed vessel. The ingredients in the vessel are then dispersed.

The dispersion is then transferred from the dry box to a reactor vessel including a mixer. The dispersion is mixed for 90 minutes to maintain the dispersion and is then heated. The reactor vessel is then subjected to repeated rounds of pulling a vacuum to 200 mtorr and refilling with nitrogen to purge the reactor vessel of oxygen and water. After three rounds of vacuum and nitrogen purging, the vessel should have an inert atmosphere.

An appropriate amount of green quantum dots and red quantum dots are then added to the reactor vessel using a Harvard syringe pump or using an airfree syringe technique. A vacuum is then pulled until 200 mtorr at which point the quantum dot formulation is complete. The photoinitiator is added to the matrix formulation after solvent is removed. The quantum dot formulation is then transferred using an air free cannula transfer technique to a container having an inert atmosphere. The quantum dot formulation substantially free of oxygen and substantially free of water can then be placed into a suitable vessel, such as a tube or capillary. Such tubes or capillaries are dried under a dry nitrogen blanket at 140° C. for about 16 hours before the quantum dot formulation is introduced into the tube or capillary to form a quantum light optic. The photoinitiator can be added to the quantum dot formulation prior to assembly of the quantum light optic.

The moisture content of quantum dot formulations can be determined by using a Metrohm 874 KF Oven Sampler with 851 Titrando (Coulometric detection with double Pt electrode) and a Scientech ZSA 210 four place analytical balance with RS232 interface for weight transfer. Samples (either solids or liquids) are weighed into an autosampler vial which is crimp sealed. The vial is then heated via a sample block heater to a pre-programmed temperature and the heated vapor is transferred via a dry carrier gas into the coulometric detection cell where the Karl Fischer reagent reacts stoichiometrically with any moisture vapor from the sample. Based on the initial starting weight of the sample, the PPM or % moisture is calculated and data transferred to local database. Sample weights and heating temperature are optimized for each particular sample type.

The Scientech balance is calibrated via an external 100 gram weight. The KF unit has an internal response/drift condition program to insure proper electrode equilibration between measurements and an external Hydranal KF Water standard.

The oxygen content of quantum dot formulations described herein can be determined using the optical oxygen sensor Mettler-Toledo 6860i which includes a sensor head, a sensor shaft and a sensor tip with a chromophore layer. The optical oxygen sensor operates on the principle of oxygen quenching of a fluorescence signal emitted by the chromophore layer when excited by an LED. The quenching depends on the amount of oxygen present in the sample being tested. According to one aspect, the quantum dot formulation is provided in a Schlenk flask. Nitrogen is flown through the shoulder of the Schlenk flask creating a blanket of nitrogen on the quantum dot formulation. The probe is inserted through the top of the Schlenk flask and dipped into the quantum dot formulation. After about 5 minutes, the measurement in ppm is recorded.

### Example VI

### Reliability Testing

The setup to test reliability consists of an array of blue LEDs (e.g. Lumileds Luxeon Rebel) with peak wavelength of 445 nm. A test capillary is subjected to a blue light flux of ˜810 mW blue optical power/LED. The test capillary is held at a distance of about 0.6 mm above the LED array. The temperature of the composition (quantum dot-containing polymer matrix) at these conditions has been determined to be ˜130° C. This is measured by placing a 1 mil Type-T thermocouple in the matrix. The thermocouple is placed in the glass capillary prior to filling and curing the ink.

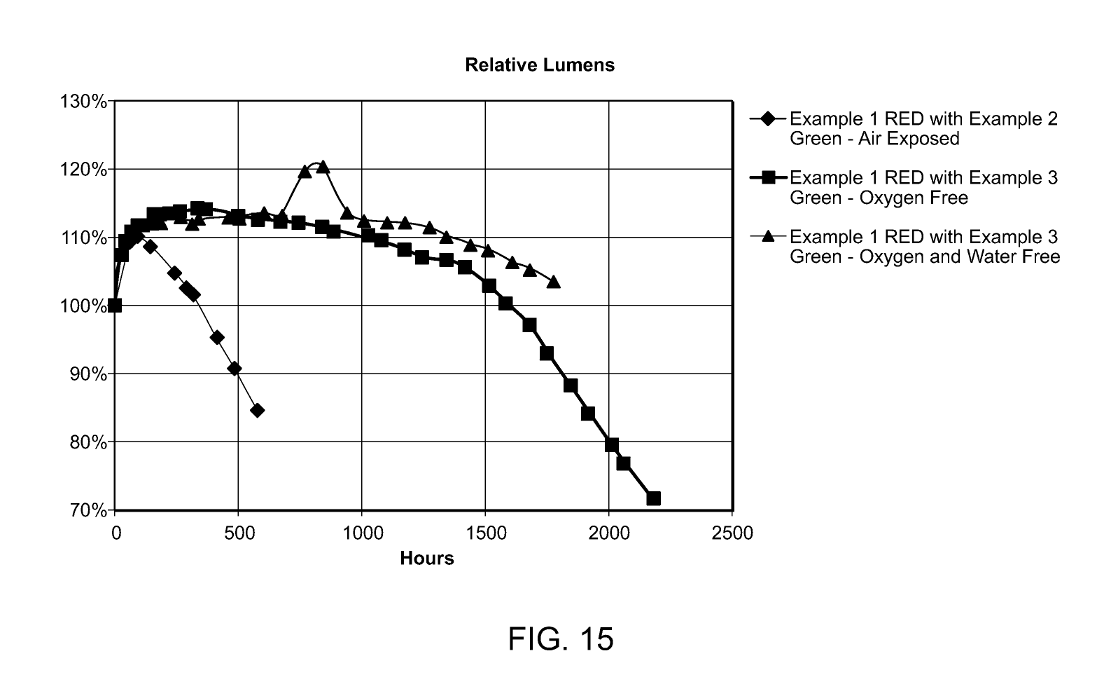

The excitation and emission spectra of the test capillary including the composition of the Examples being tested was captured during irradiation/testing using fiber coupling to a spectrometer (e.g. Avantes AvaSpec-2048). The performance of the test capillary was monitored during the period of exposure to the 445 nm blue light flux in the above-described set up. The change in performance of quantum dots in the test capillary is tracked in real time and the spectral changes are quantified in terms of relative lumens (calculated from emission spectra obtained during test). Reliability data is provided in FIG. 15.

### Example VII

### Ink Formulation

Quantum dot formulations under various amounts of oxygen are prepared as follows for use in the testing unit.

The following materials are used: Lauryl methacrylate (LMA) (Sigma-Aldrich); 1, 12-Dodecanediol dimethacrylate (D3DMA) (APHA=12, Esstech); Irgacure 2022 (BASF); Green Dots (QD Vision); Red Dots (QD Vision); TiO₂ (TiPure R902+); Fumed SiO₂ (Cab-O-Sil TS-720, Cabot); Trioctylphosphine oxide (TOPO) (Sigma-Aldrich); Dipotassium dodecyl phosphate (K2DP) (PCI); Certified O₂ ppm level (e.g. <0.15 ppm O₂, 10.5 ppm O₂, 106 ppm O₂ or 1050 ppm O₂) balanced in Helium gas.

K2DP can be prepared by known techniques. One example of such known techniques includes the following: A 250 mL beaker, placed in a 65° C. water bath and equipped with an overhead stirrer, is charged with 50.04 g dodecyl phosphate (DDP). After the DDP is melted, stirring of the molten liquid is started. To the molten DDP is slowly added 41.94 g 50% aqueous potassium hydroxide solution (KOH) followed by 37.86 g of deionized water. The water batch temperature is raised to 70° C. and the solution is stirred at this batch temperature for an additional 3 hours with an indicated solution temperature range of 60-65° C. The beaker is then removed from the overhead stirrer and water bath and placed in a vacuum oven overnight at 140° C. and <1 mm Hg resulting in the off-white dry product (dodecyl phosphate, dipotassium salt; (K2DP)).

The following protocol is used to make 40 grams of an ink formulation. Pre-dry 32.9812 g LMA and 6.2124 g D3DMA on molecular sieves. Pre-dry 0.06 g TiO₂ and 2.4 g fumed SiO₂ in a 100 mL

Schlenk flask equipped with a stir bar at vacuum oven at 140° C. overnight. Pre-dry 0.2098 g K2DP at vacuum oven at 140° C. overnight. Pre-dry 2.098 g TOPO over desiccator overnight.

Remove the flask with TiO₂ and SiO₂ from the oven and as quickly as possible, add K2DP into the flask, and stopper the flask with a red rubber septum. Attach the hot flask to a vacuum manifold and apply vacuum, and apply vacuum slowly to prevent pulling the silica into the vacuum manifold. After pressure in the flask no longer drops, apply nitrogen. Repeat vacuum degas and nitrogen pressurizing two more times and put the flask back under nitrogen. The flask is now inserted and ready for charging.

Charge TOPO to the flask under nitrogen. Charge LMA and D3DMA to the flask under nitrogen. Place the flask on a stir-plate and start stirring. Carry out vacuum degas and nitrogen pressurizing of the flask with ink for three times. Then place the flask back under nitrogen with stirring.

Under nitrogen, disperse the formulation chemicals in the flask using a Rotor Stator (IKA). Speed set to 9.8 (krpm) and disperse for 15 minutes. Carry out vacuum degas and nitrogen pressurizing of the flask with ink for three times. Then place the flask back under vacuum with stirring until the vacuum pressure no longer drops and is stabilized (usually below 40 mTorr). Apply nitrogen to the flask.

Under nitrogen, transfer green QD solution and red QD solution to the formulation flask via syringes. Stir for 5 minutes. Carry out vacuum degas and nitrogen pressurizing of the flask with ink for three times and place the flask under vacuum with stirring, until the vacuum pressure no longer drops and is stabilized (usually below 60 mTorr). Under vacuum, close the side arm of the formulation flask.

The ink is then exposed to an oxygen/helium mixed gas as follows. Equip the cylinder of certified O₂ level (e.g. 10.5 ppm O₂) in Helium with a He gas regulator. Switch the manifold hose line of the side arm of formulation flask to the O₂/He gas regulator. Regulate the outlet pressure of the O₂/He mixed gas to ˜15 psi. Still keep the side arm of the formulation flask closed, and carry out vacuum/mixed gas pressurizing throughout the manifold line for three times. Flush the manifold line with the O₂/He mixed gas for another 15 minutes. Open the side arm of the formulation flask and apply the O₂/He mixed gas to the flask under stirring. Set the time zero (time=0). Let the ink formulation stir under the mixed O₂/He gas for an extended amount of time (e.g. time=1 hour or 3 hours). Close the side arm of the formulation to the mixed gas.

Charge 0.3899 mL Irgacure 2022 to the formulation flask via syringe. Stir for 2 minutes. The formulation is introduced into capillaries using a capillary fill station described herein. The capillaries are then inserted into the test unit for testing as described herein.

### Example VIII

### Performance Testing

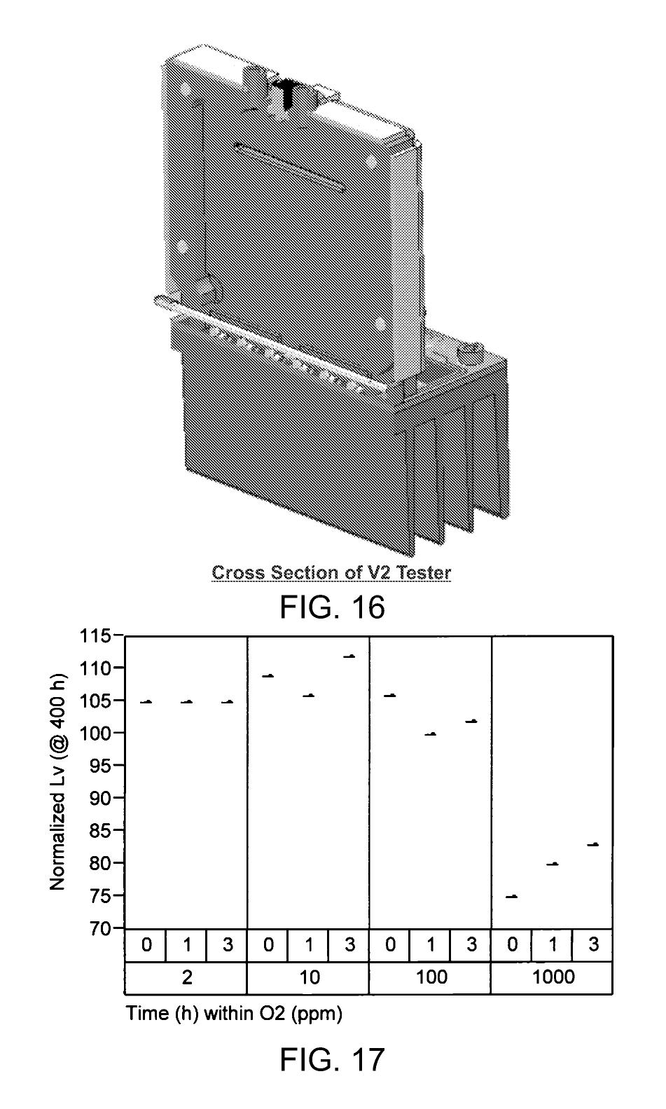

Studies were conducted on substantially oxygen free and substantially water free quantum dot formulations within capillary tubes as described herein using a testing unit shown in FIG. 16.

The testing unit included a light collection chamber made of non-yellowing Teflon and a diffuse reflective material with approximate dimensions of 62 mm×71 mm×25 mm. An optic holder made of Teflon and diffuse reflective material holds a capillary tube 0.6 mm from the top of LEDs. The light collection chamber collects and recycles light. Fiber optic ports are located at the top of the chamber for an SMA type fiber optic. A baffle is provided to block direct light from reaching the fiber optic. Black aluminum shielding is provided on the outside of the chamber to block light from entering the chamber.

One end of a fiber optic is connected to the light collection chamber and the other end of the fiber optic is connected to a spectrophotometer which measures spectral power distribution.

LEDs provide a light source. The LEDs are Lumileds Luxeon Rebel producing light at 445 nm with a one amp maximum current and 500 mW blue radiometric power when driven at 350 mA. The LEDs are operated at constant current through the life of the test. The LEDs are spaced 8.5 mm apart. The printed circuit board is an aluminum core printed circuit board with a highly reflective white soldermask designed not to yellow or brown under high temperature conditions. An exposed pad on the LED allows a thermocouple to be attached near the LED for temperature monitoring throughout the test. An aluminum heat sink is provided.

Capillary tubes including quantum dot formulations prepared as described herein and under oxygen free and water free conditions were placed within the testing unit and light measurements were taken which include lumens, CIEₓ and CIE_{y} at 810 mW/LED; Tₐ at room temperature and Tₘ at 130° C.

As shown in FIG. 17, quantum dot formulations with oxygen levels at about 100 ppm and below produced higher normalized Lv compared to quantum dot formulations with oxygen levels at about 1000 ppm.

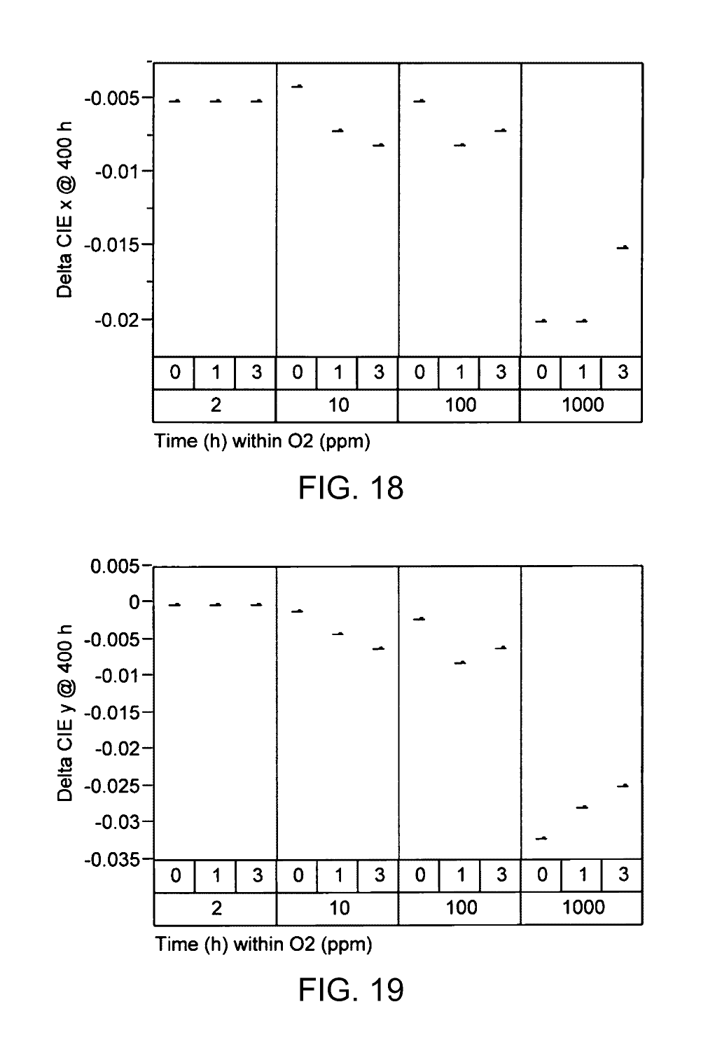

As shown in FIG. 18, quantum dot formulations with oxygen levels at about 100 ppm and below produced lower ΔCIEₓ compared to quantum dot formulations with oxygen levels at about 1000 ppm.

As shown in FIG. 19, quantum dot formulations with oxygen levels at about 100 ppm and below produced higher ΔCIE_{y} compared to quantum dot formulations with oxygen levels at about 1000 ppm.

As used herein, the singular forms “a”, “an” and “the” include plural unless the context clearly dictates otherwise. Thus, for example, reference to an emissive material includes reference to one or more of such materials.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-82. (canceled)

83. A quantum dot formulation comprising
quantum dots in combination with one or more components wherein oxygen is present in the quantum dot formulation in an amount of less than about 10 part per million.

84. A quantum dot formulation comprising
quantum dots in combination with one or more components wherein water is present in the quantum dot formulation in an amount of less than about 100 part per million.

85. A quantum dot formulation comprising
quantum dots in combination with one or more components wherein oxygen and water each is present in the quantum dot formulation in an amount of less than about 10 part per million.

86-149. (canceled)

150. A quantum dot-containing vessel comprising
a container having a quantum dot formulation therein having less than about 10 ppm oxygen.

151. A quantum dot-containing vessel comprising
a capillary having a quantum dot formulation therein having less than about 10 ppm oxygen.

152. (canceled)

153. A quantum dot-containing vessel comprising
a container having a quantum dot formulation therein having less than about 100 ppm water.

154. A quantum dot-containing vessel comprising
a capillary having a quantum dot formulation therein having less than about 100 ppm water.

155. (canceled)

156. The quantum dot-containing vessel of claim 150 being hermetically sealed.

157. The quantum dot-containing vessel of claim 151 being hermetically sealed.

158. The quantum dot-containing vessel of claim 153 being hermetically sealed.

159. The quantum dot-containing vessel of claim 154 being hermetically sealed.

160. The quantum dot formulation of claim 83 wherein water is present in the quantum dot formulation in an amount of less than about 1 part per million.

161. The quantum dot formulation of claim 83 wherein oxygen is present in the quantum dot formulation in an amount of less than about 5 parts per million.

162. The quantum dot formulation of claim 83 wherein oxygen is present in the quantum dot formulation in an amount of less than about 2 parts per million.

163. The quantum dot formulation of claim 83 wherein oxygen is present in the quantum dot formulation in an amount of less than about 1 part per million.

164. The quantum dot formulation of claim 83 wherein oxygen is present in the quantum dot formulation in an amount of less than about 500 parts per billion.

165. The quantum dot formulation of claim 84 wherein water is present in the quantum dot formulation in an amount of less than 50 parts per million.

166. The quantum dot formulation of claim 84 wherein water is present in the quantum dot formulation in an amount of less than 5 parts per million.

167. The quantum dot formulation of claim 84 wherein water is present in the quantum dot formulation in an amount of less than 2 parts per million.

168. The quantum dot formulation of claim 84 wherein water is present in the quantum dot formulation in an amount of less than 1 part per million.

169. The quantum dot formulation of claim 84 wherein oxygen is present in the quantum dot formulation in an amount of less than about 1 part per million.

170. The quantum dot formulation of claim 84 wherein oxygen is present in the quantum dot formulation in an amount of less than about 500 parts per billion.

171. The quantum dot formulation of claim 85 wherein water is present in the quantum dot formulation in an amount of less than 50 parts per million.

172. The quantum dot formulation of claim 85 wherein water is present in the quantum dot formulation in an amount of less than 5 parts per million.

173. The quantum dot formulation of claim 85 wherein water is present in the quantum dot formulation in an amount of less than 2 parts per million.

174. The quantum dot formulation of claim 85 wherein water is present in the quantum dot formulation in an amount of less than 1 part per million.

175. The quantum dot formulation of claim 85 wherein oxygen is present in the quantum dot formulation in an amount of less than about 5 parts per million.

176. The quantum dot formulation of claim 85 wherein oxygen is present in the quantum dot formulation in an amount of less than about 2 parts per million.

177. The quantum dot formulation of claim 85 wherein oxygen is present in the quantum dot formulation in an amount of less than about 1 part per million.

178. The quantum dot formulation of claim 85 wherein oxygen is present in the quantum dot formulation in an amount of less than about 500 parts per billion.
